(19) United States
(12) Patent Application Publication
(10) Pub. No.: US 2025/0031184 A1
(43) Pub. Date: Jan. 23, 2025

(54) BUNDLING PAGING OCCASIONS

(71) Applicant: Samsung Electronics Co., Ltd., Suwon-si (KR)

(72) Inventors: Anil Agiwal, Allen, TX (US); Kyeongin Jeong, Allen, TX (US); Shiyang Leng, Allen, TX (US); Hongbo Si, Allen, TX (US)

(21) Appl. No.: 18/764,048

(22) Filed: Jul. 3, 2024

Related U.S. Application Data
(60) Provisional application No. 63/527,437, filed on Jul. 18, 2023.
(60) Provisional application No. 63/527,748, filed on Jul. 19, 2023.

(51) Int. Cl. H04W 68/02

(52) U.S. Cl. CPC H04W 68/02

(57) ABSTRACT

A UE includes a transceiver. The transceiver is configured to receive a first paging configuration, and receive a second paging configuration. The UE further includes a processor operably coupled to the transceiver. The processor is configured to determine whether to apply the first or the second paging configuration, and according to the applied paging configuration, determine a paging frame (PF) and determine a paging occasion (PO) index.

### CROSS-REFERENCE TO RELATED APPLICATION(S) AND CLAIM OF PRIORITY

This application claims priority under 35 U.S.C. § 119(e) to U.S. Provisional Patent Application No. 63/527,437 filed on Jul. 18, 2023, and U.S. Provisional Patent Application No. 63/527,748 filed on Jul. 19, 2023. The above-identified provisional patent applications are hereby incorporated by reference in their entirety.

### TECHNICAL FIELD

This disclosure relates generally to wireless networks. More specifically, this disclosure relates to bundling paging occasions.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides methods and apparatuses for bundling (or clustering or grouping) paging occasions.

In one embodiment, a user equipment (UE) is provided. The UE includes a transceiver. The transceiver is configured to receive a first paging configuration, and receive a second paging configuration. The UE further includes a processor operably coupled to the transceiver. The processor is configured to determine whether to apply the first or the second paging configuration, and according to the applied paging configuration, determine a paging frame (PF) and determine a paging occasion (PO) index.

In another embodiment, abase station (BS) is provided. The BS includes a transceiver. The transceiver is configured to transmit a first paging configuration, and transmit a second paging configuration. The BS further includes a processor operably coupled to the transceiver. The processor is configured to determine whether to apply the first or the second paging configuration, and according to the applied paging configuration, determine a PF and determine a PO index.

In yet another embodiment, a method of operating a UE is provided. The method includes receiving a first paging configuration, receiving a second paging configuration, and determining whether to apply the first or the second paging configuration. The method further includes, according to the applied paging configuration, determining a PF, and determining a PO index.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2A-2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example of uniformly distributed paging frames according to embodiments of the present disclosure;

FIG. 4B illustrates an example of bundled (or grouped/clustered) paging frames according to embodiments of the present disclosure;

FIG. 5 illustrates an example of SSB periodicity according to embodiments of the present disclosure;

FIG. 6 illustrates an example of bundling (or grouping/clustering) paging frames according to embodiments of the present disclosure;

FIG. 7 illustrates a method for bundling (or grouping/clustering) paging occasions according to embodiments of the present disclosure;

FIG. 8 illustrates another example of bundling (or grouping/clustering) paging frames according to embodiments of the present disclosure;

FIG. 9 illustrates another method for bundling (or grouping/clustering) paging occasions according to embodiments of the present disclosure;

FIG. 10 illustrates another example of bundling (or grouping/clustering) paging frames according to embodiments of the present disclosure;

FIG. 11 illustrates another method for bundling (or grouping/clustering) paging occasions according to embodiments of the present disclosure;

FIG. 12 illustrates another method for bundling (or grouping/clustering) paging occasions according to embodiments of the present disclosure;

FIG. 13 illustrates another method for bundling (or grouping/clustering) paging occasions according to embodiments of the present disclosure;

FIG. 14 illustrates another method for bundling (or grouping/clustering) paging occasions according to embodiments of the present disclosure;

FIG. 15 illustrates a method for paging a UE according to embodiments of the present disclosure;

FIG. 16 illustrates a method for receiving paging according to embodiments of the present disclosure;

FIG. 17 illustrates another method for paging a UE according to embodiments of the present disclosure;

FIG. 18 illustrates another method for receiving paging according to embodiments of the present disclosure;

FIG. 19 illustrates another method for paging a UE according to embodiments of the present disclosure;

FIG. 20 illustrates another method for receiving paging according to embodiments of the present disclosure;

FIG. 21 illustrates another method for paging a UE according to embodiments of the present disclosure;

FIG. 22 illustrates another method for receiving paging according to embodiments of the present disclosure;

FIG. 23 illustrates another method for paging a UE according to embodiments of the present disclosure;

FIG. 24 illustrates another method for receiving paging according to embodiments of the present disclosure;

FIG. 25 illustrates another method for paging a UE according to embodiments of the present disclosure;

FIG. 26 illustrates another method for receiving paging according to embodiments of the present disclosure; and

FIG. 27 illustrates a method for bundling (or grouping/clustering) paging occasions according to embodiments of the present disclosure.

### DETAILED DESCRIPTION

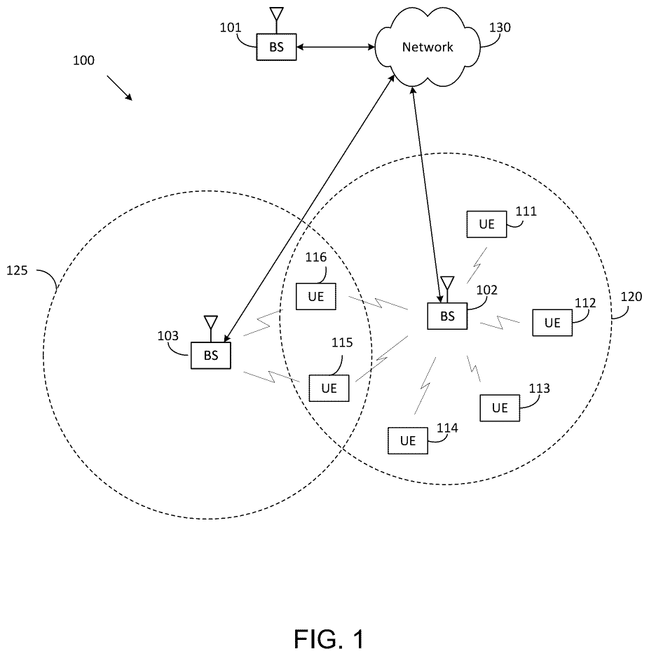

FIGS. 1 through 27, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for bundling (or grouping/clustering) paging occasions. In certain embodiments, one or more of the gNBs 101-103 includes circuitry, programing, or a combination thereof, to support bundling (or grouping/clustering) paging occasions in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

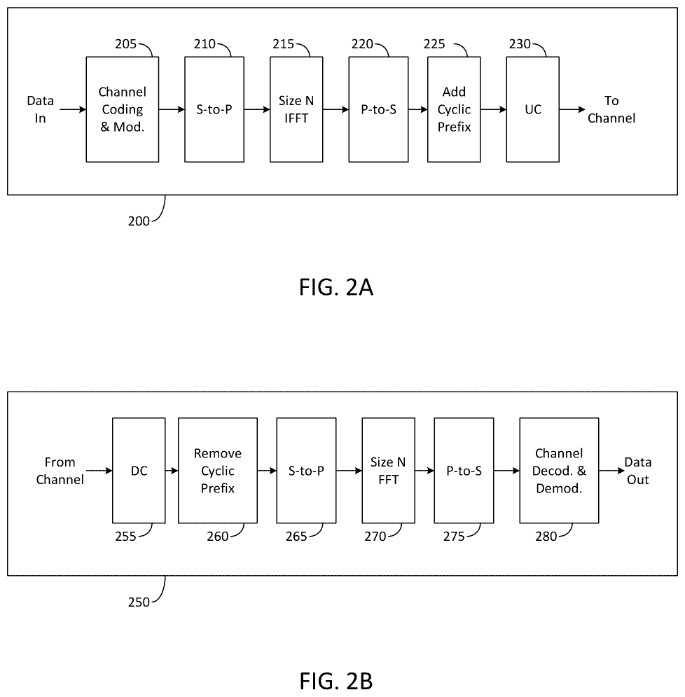

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support bundling (or grouping/clustering) paging occasions as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

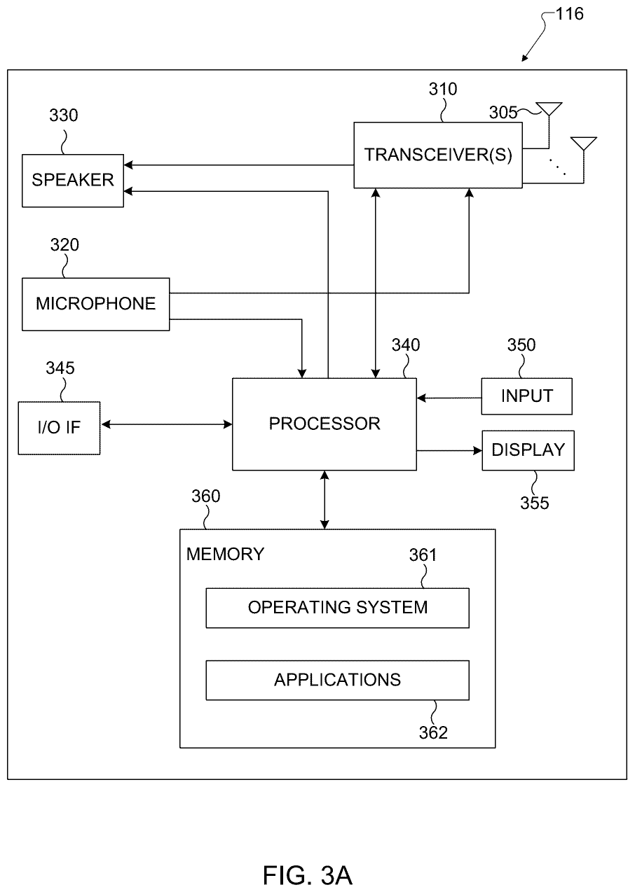

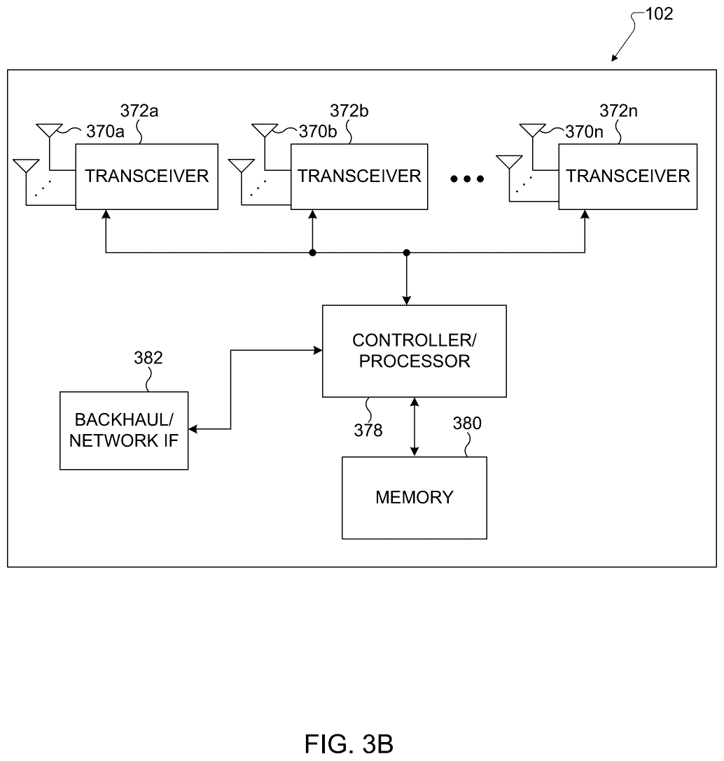

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for bundling (or grouping/clustering) paging occasions as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support bundling (or grouping/clustering) paging occasions as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G (B5G), 6G) supports not only lower frequency bands but also higher frequency (mmWave, tera hertz) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large-scale antenna techniques are being considered in the design of the fifth-generation wireless communication system. In addition, the next generation wireless communication system is expected to address different use cases having quite different requirements in terms of data rate, latency, reliability, mobility etc. However, it is expected that the design of the air-interface of the next-generation wireless communication system would be flexible enough to serve UEs having quite different capabilities depending on the use case and market segment the UE caters to service the end customer. A few example use cases the next-generation wireless communication system wireless system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility, etc., address the market segment representing the conventional wireless broadband subscribers needing internet connectivity everywhere, all the time and on the go. The m-MTC requirements like very high connection density, infrequent data transmission, very long battery life, low mobility, etc., address the market segment representing the Internet of Things (IoT)/Internet of Everything (IoE) envisioning connectivity of billions of devices. The URLL requirements like very low latency, very high reliability, variable mobility, etc., address the market segment representing Industrial automation applications, vehicle-to-vehicle/vehicle-to-infrastructure communication (foreseen as one of the enablers for autonomous cars), etc.

In the next generation wireless communication system (e.g., 5G, beyond 5G (B5G), 6G) operating in higher frequency (mmWave) bands, the UE and gNB communicate with each other using beamforming. Beamforming techniques are used to mitigate propagation path losses and to increase the propagation distance for communication at the higher frequency band. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. A wireless communication system operating at high frequency uses a plurality of narrow TX beams to transmit signals in the cell, as each narrow TX beam provides coverage to a part of cell. The narrower the TX beam, the higher the antenna gain and hence the higher the propagation distance of a signal transmitted using beamforming. A receiver can also generate a plurality of receive (RX) beam patterns of different directions. Each of these receive patterns can be also referred as a receive (RX) beam.

The next generation wireless communication system supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with CA/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR the term PCell (primary cell) refers to a serving cell in a MCG, operating on the primary frequency, in which the UE either performs the initial connection establishment procedure or initiates the connection re-establishment procedure. In NR for a UE configured with CA, a Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the next generation wireless communication system, a node B (gNB) or base station in cell broadcast Synchronization Signal and PBCH block, also referred to as a Synchronization Signal Block (SSB), comprises primary and secondary synchronization signals (PSS, SSS) and system information. System information includes common parameters needed to communicate in a cell. In the next generation wireless communication system (also referred as next generation radio or NR), System Information (SI) is divided into the MIB and a number of SIBs where: The MIB is transmitted on the BCH with a periodicity of 80 ms and repetitions made within 80 ms and it includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to an SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systeminformationAreaID. The mapping of SIBs to SI messages is configured in schedulinglnfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) from the PCell. For a PSCell and SCells, the network provides the required SI by dedicated signaling, i.e., within an RRCReconfiguration message. Nevertheless, the UE acquires the MIB of the PSCell to get SFN timing of the SCG (which may be different from MCG). Upon change of relevant SI for the SCell, the network releases and adds the concerned SCell. For PSCell, the required SI can only be changed with Reconfiguration with Sync.

In the next wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random-access procedures are supported such as contention based random access, contention free random access and each of these can be one of 2 step or 4 step random access.

In the next generation wireless communication system, a Physical Downlink Control Channel (PDCCH) is used to schedule DL transmissions on PDSCH and UL transmissions on PUSCH, where the Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the next generation wireless communication system (e.g., 5G), a list of search space configurations is signaled by a gNB for each configured BWP of a serving cell, wherein each search configuration is uniquely identified by a search space identifier. The search space identifier is unique amongst the BWPs of a serving cell. An identifier of a search space configuration to be used for a specific purpose such as paging reception, SI reception, random access response reception is explicitly signaled by the gNB for each configured BWP. In NR, the search space configuration comprises parameters Monitoring-periodicity-PDCCH-slot, Monitoring-offset-PDCCH-slot, Monitoring-symbols-PDCCH-within-slot, and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with the search space configuration. A list of CORESET configurations are signaled by the gNB for each configured BWP of a serving cell, wherein each CORESET configuration is uniquely identified by a CORESET identifier. The CORESET identifier is unique amongst the BWPs of a serving cell. Note that each radio frame is of 10 ms duration. Each radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with SSB/CSI RS of TCI state) used by the gNB for transmission of a PDCCH in the PDCCH monitoring occasions of a search space.

In the next generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring a RRC connected UE with BWP(s) and telling the UE which of the configured BWPs is currently the active one. When BA is configured, the UE only monitors PDCCH on the one active BWP i.e., it does not monitor PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5^{th} generation (also referred as NR or New Radio) wireless communication system, a UE can be in one of the following RRC states: RRC IDLE, RRC INACTIVE and RRC CONNECTED. Paging allows the network to reach UEs in an RRC_IDLE and RRC_INACTIVE state through Paging messages, and to notify UEs in an RRC_IDLE, RRC_INACTIVE and RRC_CONNECTED state of system information change and ETWS (Earthquake and Tsunami Warning System)/CMAS (Commercial Mobile Alert System) indications through ShortMessages. Both Paging messages and Short Messages are addressed with P-RNTI on PDCCH, but while the former is sent on a PCCH logical channel (TB carrying paging message is transmitted over a physical downlink shared channel [PDSCH]), the latter is sent over a PDCCH directly.

While in an RRC_IDLE state, the UE monitors the paging channels for CN-initiated paging. While in an RRC_INACTIVE state, the UE monitors paging channels for RAN-initiated paging and CN-initiated paging. A UE need not monitor paging channels continuously though. Paging discontinuous reception (DRX) is defined where the UE in RRC_IDLE or RRC_INACTIVE is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., a PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams and thus the selection of the beam(s) for the reception of the paging message and Short Message is up to UE implementation. The paging message is the same for both RAN initiated paging and CN initiated paging. The UE initiates an RRC Connection Resume procedure upon receiving RAN initiated paging. If the UE receives a CN initiated paging in an RRC_INACTIVE state, the UE moves to an RRC_IDLE state and informs the NAS.

The PF and PO for paging are determined (by the UE and the base station, e.g., gNB) by the following formulae:

SFN for the PF is determined by:

$$( SFN + PF\_offset ) mod T = ( T div N ) ⋆ ( UE\_ID mod N ) .$$

Index (i_s), indicating the index of the PO is determined by:

$$i\_s = floor ( UE\_ID / N ) mod Ns .$$

The PDCCH monitoring occasions for paging are determined according to pagingSearchSpace. When SearchSpaceId=0 is configured for pagingSearchSpace, the PDCCH monitoring occasions for paging are the same as for RMSI (also referred to as SIB1). PDCCH monitoring occasions for RMSI depend on a SS/PBCH block and CORESET multiplexing pattern. The SS/PBCH block (SSB) and CORESET multiplexing pattern is signaled in a MIB and can be one of pattern 1, pattern 2 and pattern 3. For pattern 1, the set of PDCCH monitoring occasions occur every 20 ms. For pattern 2/3, the set of PDCCH monitoring occasions occur every SSB periodicity. For pattern 3, PDCCH monitoring occasion for RMSI is FDMed with SSB. For pattern 2 PDCCH monitoring occasion for RMSI is at an offset with respect to SSB.

When SearchSpaceId=0 is configured for pagingSearchSpace, Ns is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

The following parameters are used for the calculation of PF and i_s above:

T: DRX cycle of the UE.

N: number of total paging frames in T; N is one of T, T/2, T/4, T/8, T/16.

Ns: number of paging occasions for a PF; NS is one of 1, 2, 4.

PF_offset: offset used for PF determination

UE_ID: if the UE operates in eDRX: 5G-S-TMSI mod 4096, otherwise 5G-S-TMSI mod 1024.

Parameters Ns, nAndPagingFrameOffset, and the length of default DRX Cycle are signaled in SIB1. The values of N and PF_offset are derived from the parameter nAndPagingFrameOffset as shown below

| | |
|---|---|
| - nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |
| }, | |

A value of oneSixteenthT corresponds to N=T/16, a value of oneEighthT corresponds to N=T/8, and so on.

If pagingSearchSpace is set to zero and if the SS/PBCH block and CORESET multiplexing pattern is 2 or 3, for ssb-periodicityServingCell of 5 or 10 ms, N can be set to one of {oneT, halfT quarterT, oneEighthT, oneSixteenthT}. For ssb-periodicityServingCell of 20 ms, N can be set to one of {halfT, quarterT, oneEighthT, oneSixteenthT}. For ssb-periodicityServingCell of 40 ms, N can be set to one of {quarterT, oneEighthT, oneSixteenthT}. For ssb-periodicityServingCell of 80 ms, N can be set to one of {oneEighthT, oneSixteenthT}. For ssb-periodicityServingCell of 160 ms, N can be set to oneSixteenthT

If pagingSearchSpace is set to zero and if the SS/PBCH block and CORESET multiplexing pattern is 1, N can be set to one of {halfT, quarterT, oneEighthT, oneSixteenthT}

If pagingSearchSpace is not set to zero, N can be configured to one of {oneT, halfT, quarterT, oneEighthT, oneSixteenthT}

If the UE has no 5G-S-TMSI, for instance when the UE has not yet registered onto the network, the UE shall use as default identity UE_ID=0 in the PF and i_s formulas above.

In the existing method, multiple paging frames configured by the network are uniformly distributed in time. UEs are distributed across these paging frames. Each UE monitors its PO in its PF every DRX cycle.

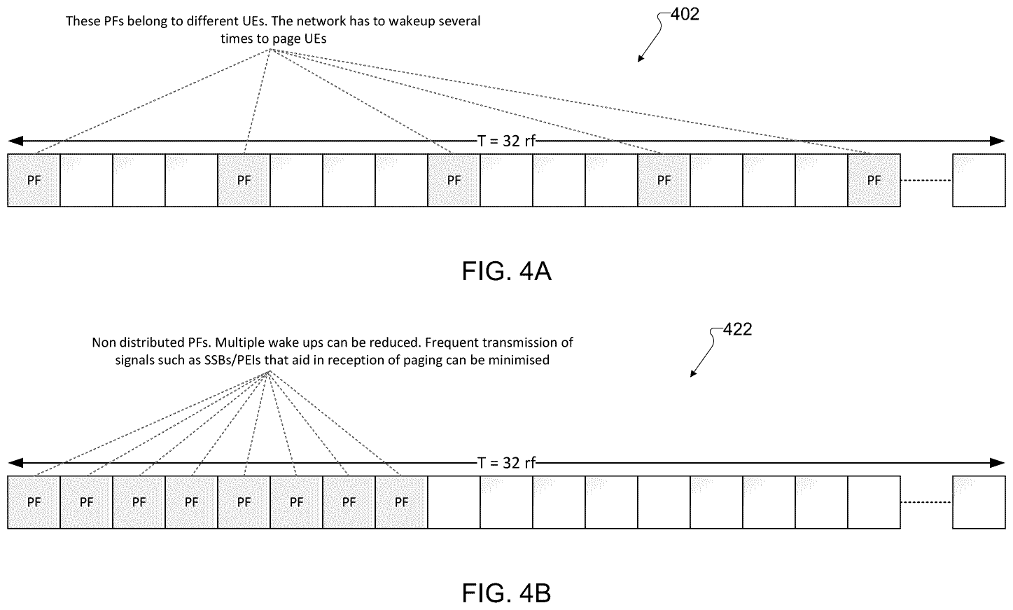

FIG. 4A illustrates an example 402 of uniformly distributed paging frames according to embodiments of the present disclosure. The embodiment of uniformly distributed paging frames of FIG. 4A is for illustration only. Different embodiments of uniformly distributed paging frames could be used without departing from the scope of this disclosure.

As shown in FIG. 4A, a PF occurs every 4 radio frames. There are 4 PFs in each period of 32 radio frames. UEs in the cell are distributed to these PFs based on UE_ID.

Although FIG. 4A illustrates an example 402 of uniformly distributed paging frames, various changes may be made to FIG. 4A. For example, various changes to the number of PFs, the PF spacing, etc. could be made according to particular needs.

An issue with distributed PFs is frequent wakeup by the network (e.g. base station) to deliver paging leading to increased energy consumption. FIG. 4B shows an approach of bundling (which can also be referred to as clustering or grouping) PFs at the beginning of a DRX cycle to reduce multiple wake ups by the network to deliver paging. Frequent transmission of signals such as SSBs/PEIs that aid in reception of paging can also be minimized with bundling (or grouping/clustering).

FIG. 4B illustrates an example 422 of bundled paging frames according to embodiments of the present disclosure. The embodiment of bundled paging frames of FIG. 4B is for illustration only. Different embodiments of bundled paging frames could be used without departing from the scope of this disclosure.

As shown in FIG. 4B, a PF occurs every radio frame for the first 8 radio frames in each period of 32 radio frames. UEs in the cell are distributed to these PFs based on UE_ID.

Although FIG. 4B illustrates an example 422 of bundled paging frames, various changes may be made to FIG. 4B. For example, various changes to the number of PFs, the periodicity, etc. could be made according to particular needs.

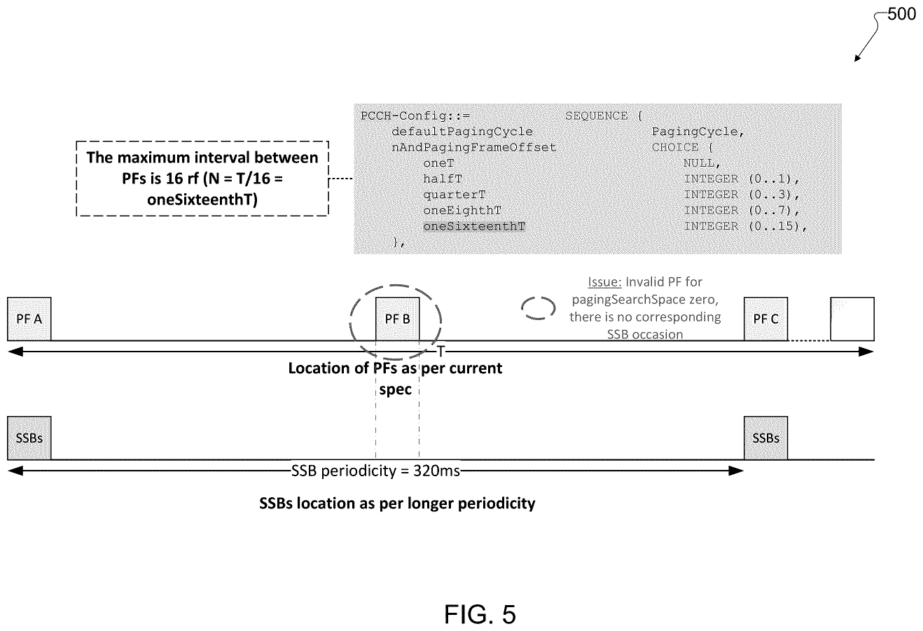

In the 5G wireless communication system, the maximum SSB periodicity is 160 ms. A longer SSB periodicity (e.g., 320 ms, 640 ms, . . . ) can improve network energy savings. However, a longer SSB periodicity impacts PF/PO determination for pagingSearchSpace 0. Some of the PFs/POs determined based on the current formula/configuration will become invalid as can be seen in FIG. 5. An enhancement to determine PFs/POs for a longer SSB periodicity is provided in the present disclosure.

FIG. 5 illustrates an example 500 of SSB periodicity according to embodiments of the present disclosure. The embodiment of SSB periodicity of FIG. 5 is for illustration only. Different embodiments of SSB periodicity could be used without departing from the scope of this disclosure.

FIG. 5 shows various PFs configured by the network. UEs are distributed amongst these PFs based on UE_ID. Some of UEs will be mapped to PF B for which there is no PDCCH monitoring occasions for paging. Note that when pagingSearchSpace is zero, if the SS/PBCH block and CORESET multiplexing pattern is 2 or 3, PDCCH monitoring occasions for paging are the same as the SSB occasions.

Although FIG. 5 illustrates an example 500 of SSB periodicity, various changes may be made to FIG. 5. For example, various changes to the number of PFs, the periodicity, etc. could be made according to particular needs.

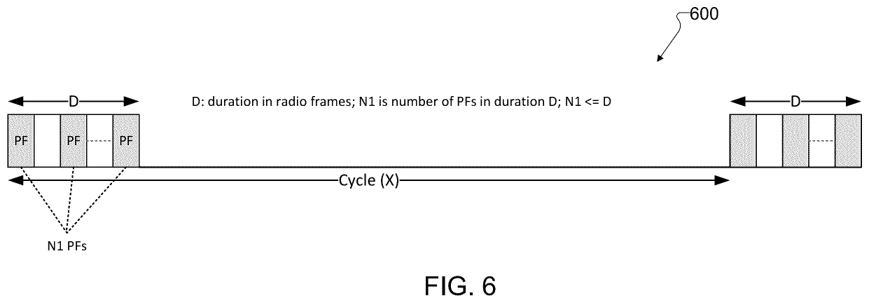

As previously described, PFs may be bundled to reduce multiple wake ups by the network (e.g. base station) to deliver paging. In one embodiment, PFs/POs can be bundled over a short duration (D) periodically as shown in FIG. 6.

FIG. 6 illustrates an example 600 of bundling paging frames according to embodiments of the present disclosure. The embodiment of bundling paging frames of FIG. 6 is for illustration only. Different embodiments of bundling paging frames could be used without departing from the scope of this disclosure.

In the example of FIG. 6, a number of PFs (N1) are bundled in a duration of radio frames (D). The duration (D) occurs periodically at an interval/cycle/period X. The number of PFs (N1) in duration D is signaled by the network e.g., base station. For example, N1=D, D/2, D/4, D/8, D/16 . . . and so on. N1 equals to D means that every radio frame in duration D is a PF. N1 equals to D/2 means that every alternate radio frame in duration D is a PF. N1 equals to D/4 means that every fourth radio frame in duration D is a PF. N1 equals to D/8 means that every eighth radio frame in duration D is a PF. N1 equals to D/16 means that every sixteenth radio frame in duration D is a PF. UEs are distributed in these PFs in duration D. In one embodiment, X can be length of Cell DTX cycle for network energy savings.

Although FIG. 6 illustrates an example 600 of bundling paging frames, various changes may be made to FIG. 6. For example, various changes to the duration of radio frames, the periodicity, etc. could be made according to particular needs.

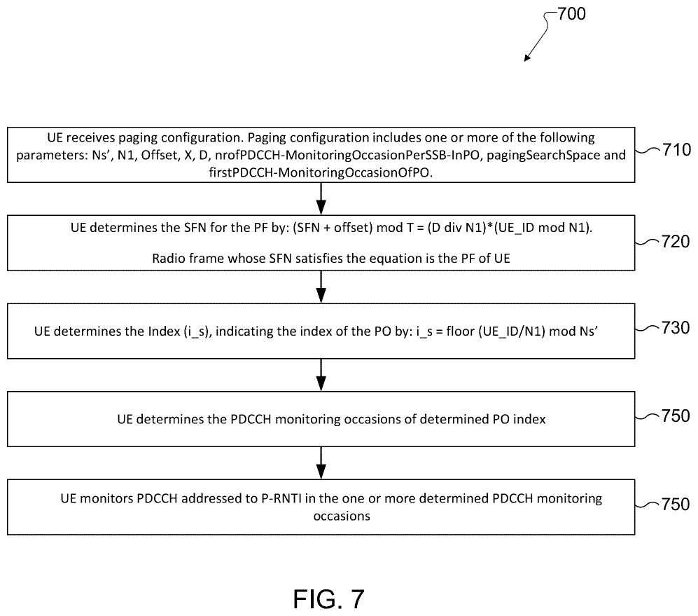

In one embodiment a UE and gNB determine a PF/PO for paging as illustrated in FIG. 7.

FIG. 7 illustrates a method 700 for bundling paging occasions according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for bundling paging occasions could be used without departing from the scope of this disclosure.

In the example of FIG. 7, a UE such as UE 116 of FIG. 1 is in an RRC_IDLE/RRC_INACTIVE state. The UE is camped to a cell. The UE acquires the system information of the camped cell.

At step 710, the UE receives a paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell. The paging configuration includes:
Ns′: number of paging occasions for a paging frame in duration D;
N1: number of paging frames in duration D
Offset
X: Interval at which bundled PFs occurs periodically
D: duration over which PFs are bundled (or configured)
nrofPDCCH-MonitoringOccasionPerSSB-InPO. This may be signaled in system information (e.g., SIB1)
firstPDCCH-MonitoringOccasionOfPO. This may be signaled in system information (e.g., SIB1) for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration.
pagingSearchSpace: Id of search space for paging.

The configuration can be per BWP or per cell. Some of the parameters such as Ns′, N1, Offset, X, D and nrofPDCCH-MonitoringOccasionPerSSB-InPO can be cell specific whereas firstPDCCH-MonitoringOccasionOfPO can be BWP specific.

The PF and PO for paging are determined (by the UE and base station e.g., gNB) by the following formulae (in case of an extended DRX cycle, the UE may determine a PF only within the paging time window):

At step 720, the SFN for the PF is determined by:
(SFN+offset) mod T=(D div N1)*(UE_ID mod N1), or
SFN mod T=(D div N1)*(UE_ID mod N1), is ‘div’ is mathematical operator indicating division and ‘*’ is a mathematical operator indicating multiplication

‘D div N1’ is an integer for N1=D, D/2, D/4, D/8, D/16 . . . . and so on. In an embodiment, D div N1 can be replaced by a parameter K which can be signalled by network and the SFN for the PF is determined by: (SFN+offset) mod T=(K)*(UE_ID mod N1), or SFN mod T=(K)*(UE_ID mod N1), where N1 is number of PFs, N1=1, 2, 3, and so on.

At step 730, the index (i_s), indicating the index of the PO is determined by:

$$i\_s = floor ( UE\_ID / N 1 ) mod {Ns}^{′} .$$

T is the DRX cycle of the UE. T may be a UE specific DRX cycle in multiples of X; or T can be X; or T is max (UE specific DRX cycle and X), or T can be as determined as specified according to technical standards such as 3GPP TS 38.304. The UE_ID is 5G-S-TMSI mod Y where Y can be 1024, 2048, 4096, 8192, 16384 etc.

At step 740, the PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns′ is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

At step 750, the UE monitors the paging (i.e., a PDCCH addressed to a P-RNTI) in the determined PF/PO. The gNB transmits the paging (i.e., the PDCCH addressed to the P-RNTI) in the determined PF/PO. In case paging early indication (PEI) is supported, the UE monitors the PEI in a PEI occasion corresponding to the determined PF/PO and the gNB transmits the PEI in a PEI occasion corresponding to the determined PF/PO. The UE shall monitor the PDCCH in its PO for paging if the subgroup to which the UE belongs is paged as indicated via an associated PEI (Paging Early Indication). If the UE cannot find its subgroup ID with the PEI configurations in a cell or if the UE is unable to monitor the associated PEI occasion corresponding to its PO, it shall monitor the paging in its PO.

In one embodiment, a UE in an RRC_IDLE or RRC_INACTIVE state may monitor a low power wakeup signal (LP WUS) using the LR if the UE and camped cell supports LP WUS. The gNB transmits the low power wakeup signal when it needs to send RAN paging or CN paging to the UE or SI/emergency notifications to the UE. If the LP WUS is received (or LP WUS for a UE/UE specific paging subgroup is received), the UE monitors for a PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

In an alternate embodiment, the UE receives a first and second paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell.

The first paging configuration includes:
Ns: number of paging occasions for a PF
N: number of paging frames
PF_Offset: paging frame offset
nrofPDCCH-MonitoringOccasionPerSSB-InPO
firstPDCCH-MonitoringOccasionOfPO
pagingSearchSpace: Id of search space for paging.

The second paging configuration includes:
Ns′: number of paging occasions for a PF
N1: number of paging frames in duration (D)
Offset
X: Interval at which bundled PFs (or configured PFs in duration D) occurs periodically
D: duration over which PFs are bundled (or configured)
nrofPDCCH-MonitoringOccasionPerSSB-InPO′
firstPDCCH-MonitoringOccasionOfPO′
pagingSearchSpace′: Id of search space for paging.

In one embodiment, Offset may not be signaled in the second paging configuration and the UE uses/applies the PF_Offset from the first paging configuration as an Offset when using the second paging configuration. If network energy savings mode is activated and/or if an indication from the network to use a PF bundling configuration (i.e., second paging configuration) is received and/or if the UE supports PF bundling configuration (i.e., second paging configuration).

The PF and PO for paging are determined (by the UE and base station e.g., gNB) by the following formulae (in case of an extended DRX cycle, the UE may determine the PF only within the paging time window:

The SFN for the PF is determined by:

$$( SFN + offset ) mod T = ( D div N 1 ) ⋆ ( UE\_ID mod N 1 ) ,$$

$$or$$

$$SFN mod T = ( D div N 1 ) ⋆ ( UE\_ID mod N 1 ) .$$

‘D div N1’ is an integer for N1=D, D/2, D/4, D/8, D/16 . . . . and so on. In an embodiment, D div N1 can be replaced by a parameter K which can be signalled by network and the SFN for the PF is determined by: (SFN+offset) mod T=(K)*(UE_ID mod N1), or SFN mod T=(K)*(UE_ID mod N1), where N1 is number of PFs, N1=1, 2, 3, and so on.

The index (i_s), indicating the index of the PO is determined by:

$$i\_s = floor ( UE\_ID / N 1 ) mod Ns ' .$$

T is the DRX cycle of the UE. T may be a UE specific DRX cycle in multiples of X; or T can be X; or T is max (UE specific DRX cycle and X), or T can be as determined as specified according to technical standards such as 3GPP TS 38.304. UE_ID is 5G-S-TMSI mod Y where Y can be 1024, 2048, 4096, 8192, 16384 etc.

The PDCCH monitoring occasions for paging are determined according to pagingSearchSpace′ and firstPDCCH-MonitoringOccasionOfPO′ and nrofPDCCH-MonitoringOccasionPerSSB-InPO′ if configured.

In one embodiment, pagingSearchSpace′ can be the same as pagingSearchSpace. In one embodiment, pagingSearchSpace is used if pagingSearchSpace′ is not configured. In one embodiment, firstPDCCH-MonitoringOccasionOfPO′ can be the same as firstPDCCH-MonitoringOccasionOfPO. In one embodiment, firstPDCCH-MonitoringOccasionOfPO is used if firstPDCCH-MonitoringOccasionOfPO′ is not configured. In one embodiment, nrofPDCCH-MonitoringOccasionPerSSB-InPO can be used if nrofPDCCH-MonitoringOccasionPerSSB-InPO′ is not configured. In one embodiment, nrofPDCCH-MonitoringOccasionPerSSB-InPO′ can be the same as nrofPDCCH-MonitoringOccasionPerSSB-InPO. In one embodiment, Ns' can be the same as Ns. In one embodiment, Ns can be used if Ns is not configured.

Otherwise (e.g., if network energy savings mode is not activated or if an indication from the network to use a PF bundling configuration is not received or if UE does not support the PF bundling configuration):

The PF and PO for paging are determined (by the UE and base station e.g., gNB) by the following formulae (in case of an extended DRX cycle, the UE may determine the PF only within the paging time window):

The SFN for the PF is determined by:

$$( SFN + PF\_offset ) mod T = ( T div N ) ⋆ ( UE\_ID mod N ) .$$

The index (i_s), indicating the index of the PO is determined by:

$$i\_s = floor ( UE\_ID / N ) mod Ns .$$

The PDCCH monitoring occasions for paging are determined according to pagingSearchSpace and firstPDCCH-MonitoringOccasionOfPO and nrofPDCCH-MonitoringOccasionPerSSB-InPO if configured.

The UE monitors the paging (i.e., a PDCCH addressed to a P-RNTI) in the determined PF/PO. The gNB transmits the paging (i.e., the PDCCH addressed to the P-RNTI) in the determined PF/PO.

The UE may also indicate its capability to support PF/PO bundling while the UE is in an RRC_CONNECTED state. The CN/AMF may send this to the gNB for idle/inactive UEs to assist the gNB to determine the PF/PO.

Although FIG. 7 illustrates one example of a method 700 for bundling paging occasions, various changes may be made to FIG. 7. For example, while shown as a series of steps, various steps in FIG. 7 could overlap, occur in parallel, occur in a different order, occur any number of times, be omitted, or replaced by other steps.

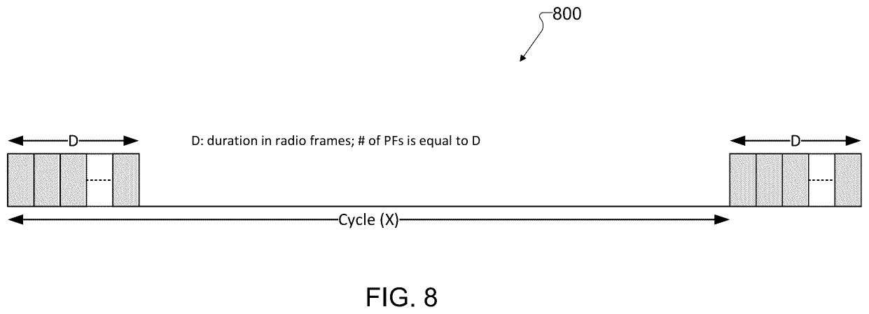

In one embodiment PFs can be bundled over a short duration (D) periodically as shown in FIG. 8.

FIG. 8 illustrates another example 800 of bundling paging frames according to embodiments of the present disclosure. The embodiment of bundling paging frames of FIG. 8 is for illustration only. Different embodiments of bundling paging frames could be used without departing from the scope of this disclosure.

In the example of FIG. 8, a number of PFs (N1) are bundled in a duration of radio frames (D). The duration (D) occurs periodically ay an interval/cycle/period X. The number of PFs in duration D is D. UEs are distributed in the PFs in duration D. In one embodiment, X can be the length of a Cell DTX cycle for network energy savings.

Although FIG. 8 illustrates an example 800 of bundling paging frames, various changes may be made to FIG. 8. For example, various changes to the duration of radio frames, the periodicity, etc. could be made according to particular needs.

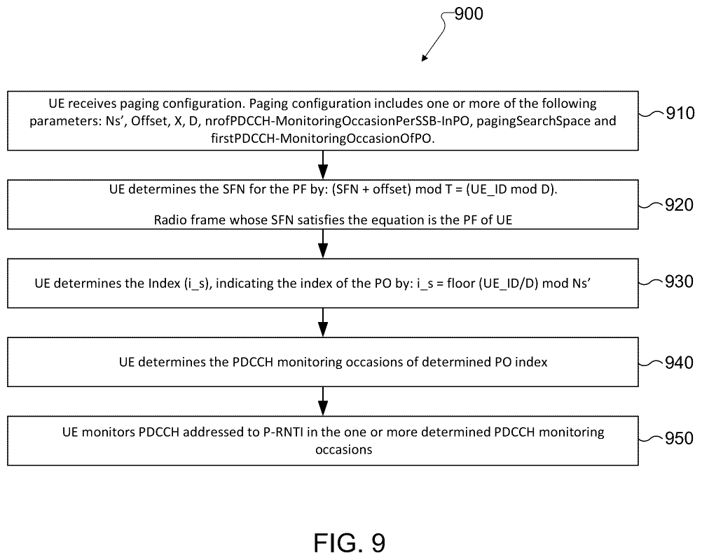

In one embodiment a UE and gNB determine the PF/PO for paging as illustrated in FIG. 9.

FIG. 9 illustrates another method 900 for bundling paging occasions according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for bundling paging occasions could be used without departing from the scope of this disclosure.

In the example of FIG. 9, a UE such as UE 116 of FIG. 1 is in an RRC_IDLE/RRC_INACTIVE state. The UE is camped to a cell. The UE acquires the system information of the camped cell.

At step 910, the UE receives a paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell. The paging configuration includes:
Ns′: number of paging occasions for a PF
Offset
X: Interval at which bundled PFs occurs periodically
D: duration over which PFs are bundled (or configured), the number of PFs is equal to D
nrofPDCCH-MonitoringOccasionPerSSB-InPO. This may be signaled in system information (e.g., SIB1)
firstPDCCH-MonitoringOccasionOfPO. This may be signaled in system information (e.g., SIB1) for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration.
pagingSearchSpace: Id of search space for paging.

The configuration can be per BWP or per cell. Some of the parameters such as Ns′, Offset, X, D and nrofPDCCH-MonitoringOccasionPerSSB-InPO can be cell specific whereas firstPDCCH-MonitoringOccasionOfPO can be BWP specific.

The PF and PO for paging are determined (by the UE and base station e.g., gNB) by the following formulae (in case of an extended DRX cycle, the UE may determine the PF only within the paging time window):

At step 920, the SFN for the PF is determined by:

$$( SFN + offset ) mod T = ( UE\_ID mod D ) ,$$

$$or$$

$$SFN mod T = ( UE ID mod D ) .$$

At step 930, Index (i_s), indicating the index of the PO is determined by: i_s=floor (UE_ID/D) mod Ns′.

T is the DRX cycle of the UE. T may be a UE specific DRX cycle in multiples of X; or T can be X; or T is max (UE specific DRX cycle and X), or T can be as determined as specified according to technical standards such as 3GPP TS 38.304. UE_ID is 5G-S-TMSI mod Y where Y can be 1024, 2048, 4096, 8192, 16384 etc.

At step 940, the PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns' is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

At step 950, the UE monitors the paging (i.e., a PDCCH addressed to a P-RNTI) in the determined PF/PO. The gNB transmits the paging (i.e., the PDCCH addressed to the P-RNTI) in the determined PF/PO. In case paging early indication (PEI) is supported, the UE monitors the PEI in a PEI occasion corresponding to the determined PF/PO and the gNB transmits the PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

In one embodiment, a UE in an RRC_IDLE or RRC_INACTIVE may monitor a Low power wakeup signal (LP WUS) using the LR if the UE and camped cell supports LP WUS. The gNB transmits the low power wakeup signal when it needs to send RAN paging or CN paging to the UE or SI/emergency notifications to the UE. If the LP WUS is received (or LP WUS for a UE/UE specific paging subgroup is received), the UE monitors PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

In an alternate embodiment, the UE receives a first and second paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell.

The first paging configuration includes:
Ns: number of paging occasions for a PF
N: number of paging frames
PF_Offset: paging frame offset
nrofPDCCH-MonitoringOccasionPerSSB-InPO
firstPDCCH-MonitoringOccasionOfPO
pagingSearchSpace: Id of search space for paging.

The second paging configuration includes:
Ns′: number of paging occasions for a PF
Offset
X: Interval at which bundled PFs occurs periodically
D: duration over which PFs are bundled (or configured), the number of PFs is equal to D
nrofPDCCH-MonitoringOccasionPerSSB-InPO′
firstPDCCH-MonitoringOccasionOfPO′
pagingSearchSpace′: Id of search space for paging.
In an embodiment, Offset may not be signaled in the second paging configuration and the UE uses/applies the PF_Offset from the first paging configuration as an Offset when using the second paging configuration.

If network energy savings mode is activated and/or if indication from a network to use the PF bundling configuration (i.e. second paging configuration) is received and/or if UE supports the PF bundling configuration (i.e. second paging configuration):

The PF and PO for paging are determined (by the UE and base station e.g., gNB) by the following formulae (in case of an extended DRX cycle, the UE may determine the PF only within the paging time window):

The SFN for the PF is determined by:

$$( SFN + offset ) mod T = ( UE\_ID mod D ) ,$$

$$or$$

$$SFN mod T = ( UE\_ID mod D ) .$$

The index (i_s), indicating the index of the PO is determined by:

$$i\_s = floor ( UE\_ID / D ) mod {Ns}^{′} .$$

T is the DRX cycle of the UE. T may be a UE specific DRX cycle in multiples of X; or T can be X; or T is max (UE specific DRX cycle and X), or T can be as determined as specified according to technical standards such as 3GPP TS 38.304. UE_ID is 5G-S-TMSI mod Y where Y can be 1024, 2048, 4096, 8192, 16384 etc.

The PDCCH monitoring occasions for paging are determined according to pagingSearchSpace′ and firstPDCCH-MonitoringOccasionOfPO′ and nrofPDCCH-MonitoringOccasionPerSSB-InPO′ if configured.

In one embodiment, pagingSearchSpace′ can be the same as pagingSearchSpace. In one embodiment, pagingSearchSpace is used if pagingSearchSpace′ is not configured. In one embodiment, firstPDCCH-MonitoringOccasionOfPO′ can be the same as firstPDCCH-MonitoringOccasionOfPO. In one embodiment, firstPDCCH-MonitoringOccasionOfPO is used if firstPDCCH-MonitoringOccasionOfPO′ is not configured. In one embodiment, nrofPDCCH-MonitoringOccasionPerSSB-InPO can be used if nrofPDCCH-MonitoringOccasionPerSSB-InPO′ is not configured. In one embodiment, nrofPDCCH-MonitoringOccasionPerSSB-InPO′ can be the same as nrofPDCCH-MonitoringOccasionPerSSB-InPO.

Otherwise (e.g., If network energy savings mode is not activated or if an indication from a network to use the PF bundling configuration is not received or if UE does not support the PF bundling configuration (i.e. second paging configuration)):

The PF and PO for paging are determined (by the UE and base station e.g., gNB) by the following formulae (in case of an extended DRX cycle, the UE may determine the PF only within the paging time window):

SFN for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured.

The UE monitors the paging (i.e., a PDCCH addressed to a P-RNTI) in the determined PF/PO. The gNB transmits the paging (i.e., the PDCCH addressed to the P-RNTI) in the determined PF/PO.

The UE may also indicate its capability to support PF/PO bundling while the UE is in an RRC_CONNECTED state. The CN/AMF may send this to the gNB for idle/inactive UEs to assist the gNB to determine the PF/PO.

Although FIG. 9 illustrates one example of a method 900 for bundling paging occasions, various changes may be made to FIG. 9. For example, while shown as a series of steps, various steps in FIG. 9 could overlap, occur in parallel, occur in a different order, occur any number of times, be omitted, or replaced by other steps.

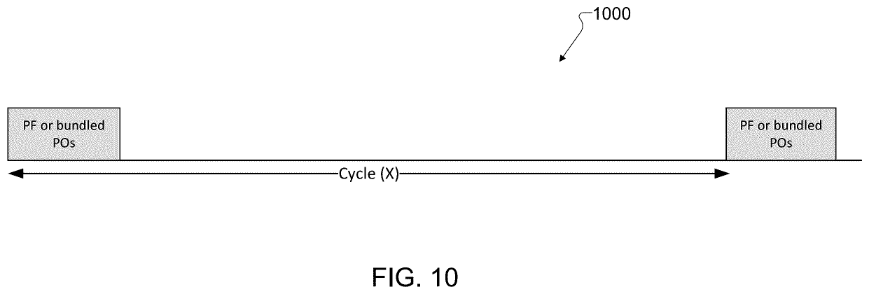

In one embodiment a PF (or reference frame for PO determination or reference frame for a cluster of POs) occurs periodically as shown in FIG. 10.

FIG. 10 illustrates another example 1000 of bundling paging frames according to embodiments of the present disclosure. The embodiment of bundling paging frames of FIG. 10 is for illustration only. Different embodiments of bundling paging frames could be used without departing from the scope of this disclosure.

In the example of FIG. 10, a PF (or reference frame for PO determination or reference frame for a cluster of POs) occurs periodically at an interval/cycle/period X.

Although FIG. 10 illustrates an example 1000 of bundling paging frames, various changes may be made to FIG. 10. For example, various changes to the PF or bundled POs, the cycle, etc. could be made according to particular needs.

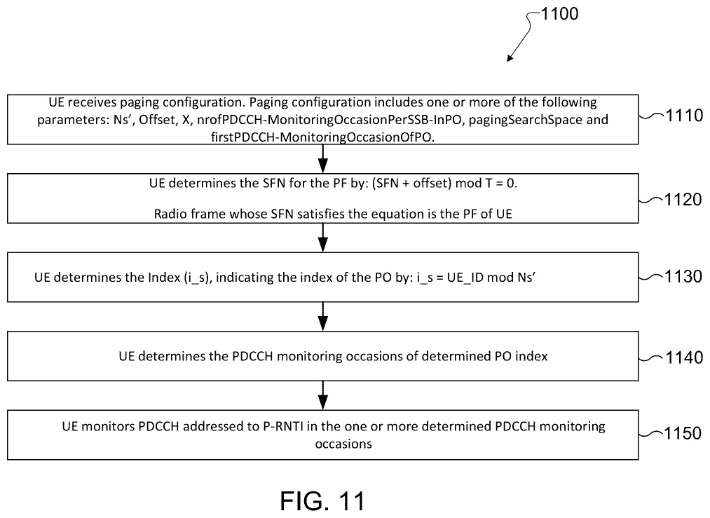

In one embodiment a UE and gNB determine the PF/PO for paging as illustrated in FIG. 11.

FIG. 11 illustrates another method 1100 for bundling paging occasions according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for bundling paging occasions could be used without departing from the scope of this disclosure.

In the example of FIG. 11, note that a PF is effectively a reference frame for PO determination or a reference frame for a cluster of POs.

In the example of FIG. 11, a UE such as UE 116 of FIG. 1 is in an RRC_IDLE/RRC_INACTIVE state. The UE is camped to a cell. The UE acquires the system information of the camped cell.

At step 1110, the UE receives a paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell. The paging configuration includes:
Ns′: number of paging occasions
Offset: offset
X: Interval between PF/reference frame/clustered POs
nrofPDCCH-MonitoringOccasionPerSSB-InPO: This may be signaled in system information (e.g., SIB1)
firstPDCCH-MonitoringOccasionOfPO: This may be signaled in system information (e.g., SIB1) for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration.
pagingSearchSpace: Id of search space for paging.

The configuration can be per BWP or per cell. Some of the parameters such as Ns′, N1, PF_Offset, X, D and nrofPDCCH-MonitoringOccasionPerSSB-InPO can be cell specific whereas firstPDCCH-MonitoringOccasionOfPO can be BWP specific.

The PF and PO for paging are determined (by the UE and base station e.g., gNB) by the following formulae:

At step 1120, the SFN for the PF is determined by:
(SFN+offset) mod T=0 or SFN mod T=offset, or
SFN mod T=0.

At step 1130, the index (i_s), indicating the index of the PO is determined by:
i_s=UE_ID mod Ns′.

T is the DRX cycle of the UE. T may be a UE specific DRX cycle in multiples of X; or T can be X; or T is max (UE specific DRX cycle and X), or T can be as determined as specified according to technical standards such as 3GPP TS 38.304. UE_ID is 5G-S-TMSI mod Y where Y can be 1024, 2048, 4096, 8192, 16384 etc.

At step 1140, the PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns' is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

At step 1150, the UE monitors the paging (i.e., a PDCCH addressed to a P-RNTI) in the determined PF/PO. The gNB transmits the paging (i.e., the PDCCH addressed to the P-RNTI) in the determined PF/PO. In case paging early indication (PEI) is supported, the UE monitors the PEI in a PEI occasion corresponding to the determined PF/PO and the gNB transmits the PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

In one embodiment, UE in RRC_IDLE or RRC_INACTIVE may monitor a Low power wakeup signal (LP WUS) using the LR if the UE and camped cell supports LP WUS. The gNB transmits a low power wakeup signal when it needs to send RAN paging or CN paging to the UE or SI/emergency notifications to the UE. If the LP WUS is received (or the LP WUS for the UE/UE specific paging subgroup is received), the UE monitors PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

In an alternate embodiment, the UE receives a first and second paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell.

The first paging configuration includes:
Ns: number of paging occasions for a PF
N: number of paging frames
PF_Offset: paging frame offset
nrofPDCCH-MonitoringOccasionPerSSB-InPO
firstPDCCH-MonitoringOccasionOfPO
pagingSearchSpace: Id of search space for paging.

The second paging configuration includes:
Ns′: number of paging occasions
Offset: offset
X: Interval
nrofPDCCH-MonitoringOccasionPerSSB-InPO′
firstPDCCH-MonitoringOccasionOfPO′
pagingSearchSpace′: Id of search space for paging.
In an embodiment, Offset may not be signaled in the second paging configuration and the UE uses/applies the PF_Offset from the first paging configuration as an Offset when using the second paging configuration.

If network energy savings mode is activated and/or if an indication from a network to use the PF bundling configuration is received and/or if the UE supports the PF bundling configuration (i.e. second paging configuration):

The PF and PO for paging are determined (by the UE and base station e.g., gNB) by the following formulae:

The SFN for the PF is determined by:
(SFN+offset) mod T=0 or SFN mod T=offset, or
SFN mod T=0.

The index (i_s), indicating the index of the PO is determined by:
i_s=UE_ID mod Ns′.

T is the DRX cycle of the UE. T may be a UE specific DRX cycle in multiples of X; or T can be X; or T is max (UE specific DRX cycle and X), or T can be as determined as specified according to technical standards such as 3GPP TS 38.304. UE_ID is 5G-S-TMSI mod Y where Y can be 1024, 2048, 4096, 8192, 16384 etc.

The PDCCH monitoring occasions for paging are determined according to pagingSearchSpace′ and firstPDCCH-MonitoringOccasionOfPO′ and nrofPDCCH-MonitoringOccasionPerSSB-InPO′ if configured.

In one embodiment, pagingSearchSpace′ can be the same as pagingSearchSpace. In one embodiment, pagingSearchSpace is used if pagingSearchSpace′ is not configured. In one embodiment, firstPDCCH-MonitoringOccasionOfPO′ can be the same as firstPDCCH-MonitoringOccasionOfPO. In one embodiment, firstPDCCH-MonitoringOccasionOfPO is used if firstPDCCH-MonitoringOccasionOfPO′ is not configured. In one embodiment, nrofPDCCH-MonitoringOccasionPerSSB-InPO can be used if nrofPDCCH-MonitoringOccasionPerSSB-InPO′ is not configured. In one embodiment, nrofPDCCH-MonitoringOccasionPerSSB-InPO′ can be the same as nrofPDCCH-MonitoringOccasionPerSSB-InPO. In one embodiment, Ns' can be the same as Ns. In one embodiment, Ns can be used if Ns is not configured.

Otherwise (e.g., If network energy savings mode is not activated or if an indication from a network to use the PF bundling configuration is not received or if the UE does not support the PF bundling configuration (i.e. second paging configuration)):

The PF and PO for paging are determined (by the UE and base station e.g., gNB) by the following formulae:

The SFN for the PF is determined by:

$$( SFN + PF\_offset ) mod T = ( T div N ) * ( UE\_ID mod N )$$

The index (i_s), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured.

The UE monitors the paging (i.e., a PDCCH addressed to a P-RNTI) in the determined PF/PO. The gNB transmits the paging (i.e., the PDCCH addressed to the P-RNTI) in the determined PF/PO.

The UE may also indicate its capability to support PF/PO bundling while the UE is in an RRC_CONNECTED state. The CN/AMF may send this to the gNB for idle/inactive UEs to assist the gNB to determine the PF/PO.

Although FIG. 11 illustrates one example of a method 1100 for bundling paging occasions, various changes may be made to FIG. 11. For example, while shown as a series of steps, various steps in FIG. 11 could overlap, occur in parallel, occur in a different order, occur any number of times, be omitted, or replaced by other steps.

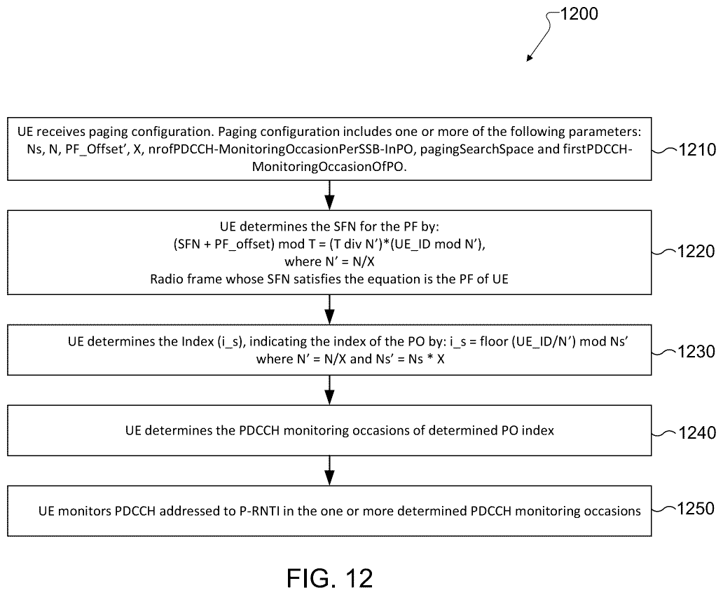

In one embodiment a UE and gNB determine the PF/PO for paging as illustrated in FIG. 12.

FIG. 12 illustrates another method 1200 for bundling paging occasions according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for bundling paging occasions could be used without departing from the scope of this disclosure.

In the example of FIG. 12, the values of N are extended to have an increased interval between PFs. To compensate for the decrease in the number of PFs over time, the number of POs per PF is increased.

In the example of FIG. 12, a UE such as UE 116 of FIG. 1 is in an RRC_IDLE/RRC_INACTIVE state. The UE is camped to a cell. The UE acquires the system information of the camped cell.

At step 1210, the UE receives a paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell. The paging configuration includes:
Ns: number of paging occasions for a PF
N: number of paging frames. N=T, T/2, T/4, T/8, T/16, etc.
Scaling factor: X (e.g., 2, 4, 8, 16, etc.), X is an integer greater than zero.
PF_Offset: paging frame offset
nrofPDCCH-MonitoringOccasionPerSSB-InPO: This may be signaled in system information (e.g., SIB1)
firstPDCCH-MonitoringOccasionOfPO: This may be signaled in system information (e.g., SIB1) for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration
pagingSearchSpace: Id of search space for paging.

The configuration can be per BWP or per cell. Some of the parameters such as Ns, N, PF_Offset, and nrofPDCCH-MonitoringOccasionPerSSB-InPO can be cell specific whereas firstPDCCH-MonitoringOccasionOfPO can be BWP specific.

The PF and PO for paging are determined (by the UE and base station e.g., gNB) by the following formulae (in case of an extended DRX cycle, the UE may determine the PF only within the paging time window):

At step 1220, the SFN for the PF is determined by:

$$( SFN + PF\_offset ) mod T = ( T div {N}^{′} ) * ( UE\_ID mod {N}^{′} )$$

At step 1230, the index (i_s), indicating the index of the PO is determined by:
i_s=floor (UE_ID/N′) mod Ns' where:

In one embodiment, N′=N/X (alternately N′=N*X, in this case X can be for example ½, ¼, ⅛, 1/16, etc. other values are not precluded)

In one embodiment, Ns'=Ns*X (alternately Ns'=Ns/X, in this case X can be for example ½, ¼, ⅛, 1/16, etc. other values are not precluded)

In one embodiment, the network may signal nAndPagingFrameOffset-V19xx.

| | |
|---|---|
| nAndPagingFrameOffset-V19xx | CHOICE { |
| oneThirtytwothT (T/32) | INTEGER (0..31), |
| oneSixtyFourthT (T/64) | INTEGER (0..63), |
| oneOneTwentyeighthT (T/128) | INTEGER (0..127), |
| oneTwofiftySixthT (T/256) | INTEGER (0..255), |
| : | |
| }, | |

The UE applies N′=the value of N indicated by nAndPagingFrameOffset-V19xx; PF_offset indicated by nAndPagingFrameOffset-V19xx is also applied to determine PF/PO. If nAndPagingFrameOffset-V19xx is configured, UE ignores nAndPagingFrameOffset (without suffix). If nAndPagingFrameOffset-V19xx is not configured, UE applies N′=N indicated by nAndPagingFrameOffset (without suffix). In one embodiment, the network may signal N‘ and N’ is applied to determine the PF/PO. The UE ignores N configured by nAndPagingFrameOffset. If N′ is not configured, the UE applies N′=N indicated by nAndPagingFrameOffset.

In one embodiment, the network may signal ns-v19xx. ns-v19xx indicates large values of Ns (larger than 4). UE applies Ns'=the value of Ns indicated by ns-V19xx; If n-V19xx is configured, UE ignores ns (without suffix). If ns-V19xx is not configured, UE applies Ns'=Ns indicated by ns (without suffix).

In one embodiment, the network may signal ns-v19xx and not signal nAndPagingFrameOffset-V19xx. In one embodiment network may not signal ns-v19xx and signal nAndPagingFrameOffset-V19xx.

T is the DRX cycle of the UE. T may be a UE specific DRX cycle; or T is max (UE specific DRX cycle and Default DRX cycle), or T can be as determined as specified according to technical standards such as 3GPP TS 38.304. UE_ID is 5G-S-TMSI mod Y where Y can be 1024, 2048, 4096, 8192, 16384 etc.

At step 1240, the PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns′ is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

At step 1250, the UE monitors the paging (i.e., a PDCCH addressed to a P-RNTI) in the determined PF/PO. The gNB transmits the paging (i.e., the PDCCH addressed to the P-RNTI) in the determined PF/PO. In case paging early indication (PEI) is supported, the UE monitors the PEI in a PEI occasion corresponding to the determined PF/PO and the gNB transmits the PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

In one embodiment, a UE in an RRC_IDLE or RRC_INACTIVE may monitor a Low power wakeup signal (LP WUS) using the LR if the UE and camped cell supports LP WUS. The gNB transmits the low power wakeup signal when it needs to send RAN paging or CN paging to the UE or SI/emergency notifications to the UE. If the LP WUS is received (or the LP WUS for the UE/UE specific paging subgroup is received), the UE monitors PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

If network energy savings mode is activated or if an indication from a network to use the PF bundling configuration is received and/or if the UE supports the PF bundling configuration:

The PF and PO for paging are determined (by the UE and base station e.g., gNB) by the following formulae (in case of an extended DRX cycle, the UE may determine the PF only within the paging time window):

The SFN for the PF is determined by:

$$( SFN + PF\_offset ) mod T = ( T div {N}^{′} ) * ( UE\_ID mod {N}^{′} )$$

The index (i_s), indicating the index of the PO is determined by:
i_s=floor (UE_ID/N′) mod Ns′ where

In one embodiment, N′=N/X (alternately N′=N*X, in this case X can be for example ½, ¼, ⅛, 1/16, etc. other values are not precluded)

In one embodiment, Ns′=Ns*X (alternately Ns′=Ns/X, in this case X can be for example ½, ¼, ⅛, 1/16, etc. other values are not precluded)

In one embodiment, the network may signal nAndPagingFrameOffset-V19xx.

| | |
|---|---|
| nAndPagingFrameOffset-V19xx | CHOICE { |
| oneThirtytwothT (T/32) | INTEGER (0..31), |
| oneSixtyFourthT (T/64) | INTEGER (0..63), |
| oneOneTwentyeighthT (T/128) | INTEGER (0..127), |
| oneTwofiftySixthT (T/256) | INTEGER (0..255), |
| : | |
| }, | |

The UE applies N′=the value of N indicated by nAndPagingFrameOffset-V19xx; PF_offset indicated by nAndPagingFrameOffset-V19xx is also applied to determine PF/PO. If nAndPagingFrameOffset-V19xx is configured, the UE ignores nAndPagingFrameOffset (without suffix). If nAndPagingFrameOffset-V19xx is not configured, the UE applies N′=N indicated by nAndPagingFrameOffset (without suffix). In one embodiment, the network may signal N′ and N′ is applied to determine PF/PO. The UE ignores N configured by nAndPagingFrameOffset. If N′ is not configured, the UE applies N′=N indicated by nAndPagingFrameOffset.

In one embodiment, the network may signal ns-v19xx. ns-v19xx indicates large values of Ns (larger than 4). The UE applies Ns′=the value of Ns indicated by ns-V19xx. If n-V19xx is configured, the UE ignores ns (without suffix). If ns-V19xx is not configured, the UE applies Ns′=Ns indicated by ns (without suffix).

In one embodiment the network may signal ns-v19xx and not signal nAndPagingFrameOffset-V19xx. In one embodiment network may not signal ns-v19xx and signal nAndPagingFrameOffset-V19xx.

The PDCCH monitoring occasions for paging are determined according to pagingSearchSpace′ and firstPDCCH-MonitoringOccasionOfPO′ and nrofPDCCH-MonitoringOccasionPerSSB-InPO′ if configured.

In one embodiment, pagingSearchSpace′ can be the same as pagingSearchSpace. In one embodiment, pagingSearchSpace is used if pagingSearchSpace′ is not configured. In one embodiment, firstPDCCH-MonitoringOccasionOfPO′ can be the same as firstPDCCH-MonitoringOccasionOfPO. In one embodiment, firstPDCCH-MonitoringOccasionOfPO is used if firstPDCCH-MonitoringOccasionOfPO′ is not configured. In one embodiment, nrofPDCCH-MonitoringOccasionPerSSB-InPO can be used if nrofPDCCH-MonitoringOccasionPerSSB-InPO′ is not configured. In one embodiment, nrofPDCCH-MonitoringOccasionPerSSB-InPO′ can be the same as nrofPDCCH-MonitoringOccasionPerSSB-InPO. In one embodiment, Ns′ can be the same as Ns. In one embodiment, Ns can be used if Ns is not configured.

Otherwise (e.g., if network energy savings mode is not activated or if an indication from the network to use the PF bundling configuration is not received or if the UE does not support the PF bundling configuration):

PF and PO for paging are determined (by the UE and base station e.g., gNB) by the following formulae (in case of an extended DRX cycle, the UE may determine the PF only within the paging time window):

SFN for the PF is determined by:

$$( SFN + PF\_offset ) mod T = ( T div N ) * ( UE\_ID mod N )$$

The index (i_s), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured.

The UE monitors the paging (i.e., a PDCCH addressed to a P-RNTI) in the determined PF/PO. The gNB transmits the paging (i.e., the PDCCH addressed to the P-RNTI) in the determined PF/PO.

The UE may also indicate its capability to support PF/PO bundling or extended value of N and/or Ns while the UE is in an RRC_CONNECTED state. The CN/AMF may send this to the gNB for idle/inactive UEs to assist the gNB to determine the PF/PO.

Although FIG. 12 illustrates one example of a method 1200 for bundling paging occasions, various changes may be made to FIG. 12. For example, while shown as a series of steps, various steps in FIG. 12 could overlap, occur in parallel, occur in a different order, occur any number of times, be omitted, or replaced by other steps.

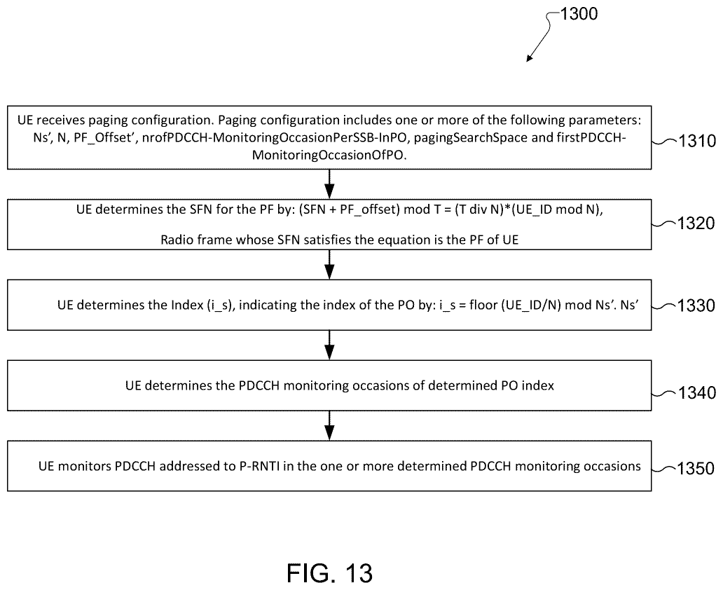

In one embodiment a UE and gNB determine the PF/PO for paging as illustrated in FIG. 13.

FIG. 13 illustrates another method 1300 for bundling paging occasions according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for bundling paging occasions could be used without departing from the scope of this disclosure.

In the example of FIG. 13, the values of N are extended to have an increased number of POs per PF.

In the example of FIG. 13, a UE such as UE 116 of FIG. 1 is in an RRC_IDLE/RRC_INACTIVE state. The UE is camped to a cell. The UE acquires the system information of the camped cell.

At step 1310, the UE receives a paging configuration for monitoring paging from the camped cell. The paging configuration may be signaled in system information (e.g., SIB1) by the camped cell. UE may receive the paging configuration of the camped cell from the camped cell, or the UE may receive the paging configuration of the camped cell from another cell. The paging configuration includes:
Ns′: number of paging occasions for a PF
N: number of paging frames. N=T, T/2, T/4, T/8, T/16, etc. (In an embodiment the network can set N such that N is equal to 1, e.g. if T is 16 radio frames, N can be set to T/16 such that N=T/16=16/16=1; e.g. if T is 8 radio frames, N can be set to T/8 such that N=T/8=8/8=1 and so on)
PF_Offset: paging frame offset
nrofPDCCH-MonitoringOccasionPerSSB-InPO. This may be signaled in system information (e.g., SIB1)
firstPDCCH-MonitoringOccasionOfPO. This may be signaled in system information (e.g., SIB1) for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration
pagingSearchSpace: Id of search space for paging.

The configuration can be per BWP or per cell. Some of the parameters such as Ns′, N, PF_Offset, and nrofPDCCH-MonitoringOccasionPerSSB-InPO can be cell specific whereas firstPDCCH-MonitoringOccasionOfPO can be BWP specific.

The PF and PO for paging are determined (by the UE and base station e.g., gNB) by the following formulae (in case of an extended DRX cycle, the UE may determine the PF only within the paging time window):

At step 1320, the SFN for the PF is determined by:

$$( SFN + PF\_offset ) mod T = ( T div N ) * ( UE\_ID mod N )$$

At step 1330, the index (i_s), indicating the index of the PO is determined by:
i_s=floor (UE_ID/N) mod Ns′ where

In one embodiment, the network may signal a second configuration of Ns (e.g. ns-v19xx). The second configuration of Ns (e.g. ns-v19xx) may indicate large values of Ns (larger than 4). The UE applies Ns′=the value of Ns indicated by second configuration of Ns (e.g. ns-V19xx); If the second configuration of Ns (e.g. ns-V19xx) is configured, the UE ignores the first configuration of Ns (e.g. ns (without suffix)0. If the second configuration of Ns (e.g. ns-V19xx) is not configured, the UE applies Ns′=Ns indicated by the first configuration of Ns (e.g., ns (without suffix)).

In an embodiment, if the UE supports Ns′:
i_s=floor (UE_ID/N) mod Ns′ or
(alternately) i_s=Ns+floor (UE_ID/N) mod Ns′ (in an embodiment, in this case Ns′ can have the same value as Ns)
(alternately) i_s=Ns+floor (UE_ID/N) mod (Ns′−Ns)

otherwise:

$$i\_s = floor ( UE\_ID / N ) mod Ns$$

Ns′=value indicated by the second configuration of Ns (e.g., ns-v19xx (values larger than 4))

Ns=value indicated by the first configuration of Ns (e.g. ns (without suffix))n

T is the DRX cycle of the UE. T may be a UE specific DRX cycle; or T is max (UE specific DRX cycle and Default DRX cycle), or T can be as determined as specified according to technical standards such as 3GPP TS 38.304. UE_ID is 5G-S-TMSI mod Y where Y can be 1024, 2048, 4096, 8192, 16384 etc.

At step 1340, the PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns′ is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

At step 1350, the UE monitors the paging (i.e., a PDCCH addressed to a P-RNTI) in the determined PF/PO. The gNB transmits the paging (i.e., the PDCCH addressed to the P-RNTI) in the determined PF/PO. In case paging early indication (PEI) is supported, the UE monitors the PEI in a PEI occasion corresponding to the determined PF/PO and the gNB transmits the PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

In one embodiment, a UE in an RRC_IDLE or RRC_INACTIVE state may monitor a Low power wakeup signal (LP WUS) using the LR if the UE and the camped cell support the LP WUS. The gNB transmits the low power wakeup signal when it needs to send RAN paging or CN paging to the UE or SI/emergency notifications to the UE. If the LP WUS is received (or LP WUS for UE/UE specific paging subgroup is received), the UE monitors PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

The UE may also indicate its capability to support PF/PO bundling or extended value of N and/or Ns while the UE is in an RRC_CONNECTED state. The CN/AMF may send this to the gNB for idle/inactive UEs to assist the gNB to determine the PF/PO.

Although FIG. 13 illustrates one example of a method 1300 for bundling paging occasions, various changes may be made to FIG. 13. For example, while shown as a series of steps, various steps in FIG. 13 could overlap, occur in parallel, occur in a different order, occur any number of times, be omitted, or replaced by other steps.

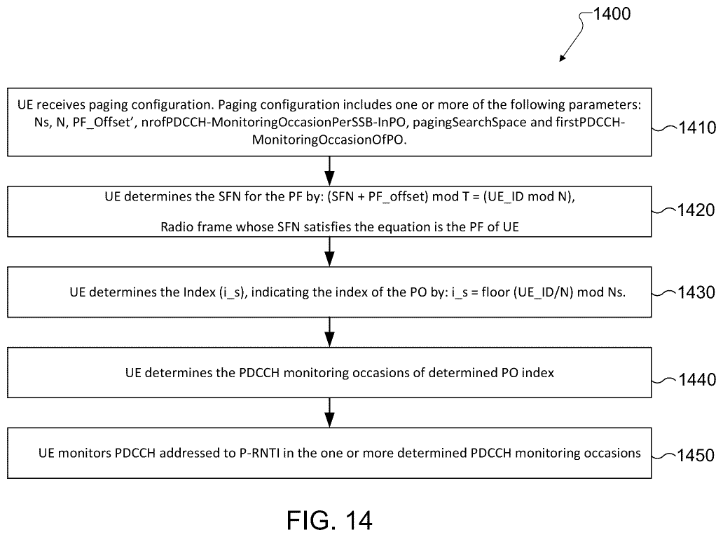

In one embodiment a UE and gNB determine the PF/PO for paging as illustrated in FIG. 14.

FIG. 14 illustrates another method 1400 for bundling paging occasions according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for bundling paging occasions could be used without departing from the scope of this disclosure.

In the example of FIG. 14, the distribution factor (T div N) is removed from the PF determination.

In the example of FIG. 14, a UE such as UE 116 of FIG. 1 is in an RRC_IDLE/RRC_INACTIVE state. The UE is camped to a cell. The UE acquires the system information of the camped cell.

At step 1410, the UE receives a paging configuration for monitoring paging from the camped cell. The paging configuration may be signaled in system information (e.g., SIB1) by the camped cell. The UE may receive the paging configuration of the camped cell from the camped cell, or the UE may receive the paging configuration of the camped cell from another cell. The paging configuration includes:
Ns: number of paging occasions for a PF
N: number of paging frames
PF_Offset: paging frame offset
nrofPDCCH-MonitoringOccasionPerSSB-InPO. This may be signaled in system information (e.g., SIB1)
firstPDCCH-MonitoringOccasionOfPO. This may be signaled in system information (e.g., SIB1) for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration
pagingSearchSpace: Id of search space for paging.

The configuration can be per BWP or per cell. Some of the parameters such as Ns, N, PF_Offset, and nrofPDCCH-MonitoringOccasionPerSSB-InPO can be cell specific whereas firstPDCCH-MonitoringOccasionOfPO can be BWP specific.

The PF and PO for paging are determined (by the UE and base station e.g., gNB) by the following formulae (in case of an extended DRX cycle, the UE may determine the PF only within the paging time window):

At step 1420, the SFN for the PF is determined by:

$$( SFN + PF\_offset ) mod T = ( UE\_ID mod N ) .$$

In an alternate embodiment, if a 1 bit indicator is in SI (e.g., clustered/bundled PF/PO set to true), the SFN for the PF is determined by:

$$( SFN + PF\_Offset ) mod T = UE\_ID mod N$$

Otherwise, the SFN for the PF is determined by:

$$( SFN + PF\_Offset ) mod T = ( T div N ) * ( UE\_ID mod N ) .$$

In an alternate embodiment, if NES mode is activated the SFN for the PF is determined by:

$$( SFN + PF\_Offset ) mod T = UE\_ID mod N .$$

Otherwise, the SFN for the PF is determined by:

$$( SFN + PF\_Offset ) mod T = ( T div N ) ⋆ ( UE\_ID mod N ) .$$

At step 1430, the index (i_s), indicating the index of the PO is determined by:
i_s=floor (UE_ID/N) mod Ns where

T is the DRX cycle of the UE. T is DRX cycle signaled in SI; or T is max (UE specific DRX cycle and Default DRX cycle), or T can be as determined as specified according to technical standards such as 3GPP TS 38.304. UE_ID is 5G-S-TMSI mod Y where Y can be 1024, 2048, 4096, 8192, 16384 etc.

At step 1440, The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns′ is either 1 or 2. For Ns=1, there is only one PO which starts from the first PDCCH monitoring occasion for paging in the PF. For Ns=2, the PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter. Otherwise, it is equal to i_s*S*X. If X>1, when the UE detects a PDCCH transmission addressed to a P-RNTI within its PO, the UE is not required to monitor the subsequent PDCCH monitoring occasions for this PO.

At step 1450, the UE monitors the paging (i.e., a PDCCH addressed to a P-RNTI) in the determined PF/PO. The gNB transmits the paging (i.e., the PDCCH addressed to the P-RNTI) in the determined PF/PO. In case paging early indication (PEI) is supported, the UE monitors the PEI in a PEI occasion corresponding to determined PF/PO and the gNB transmits the PEI in a PEI occasion corresponding to determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

In one embodiment, a UE in an RRC_IDLE or RRC_INACTIVE state may monitor Low power wakeup signal (LP WUS) using the LR if the UE and the camped cell support the LP WUS. The gNB transmits the low power wakeup signal when it needs to send RAN paging or CN paging to the UE or SI/emergency notifications to the UE. If the LP WUS is received (or LP WUS for the UE/UE specific paging subgroup is received), the UE monitors PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

The UE may also indicate its capability to support PF/PO bundling or extended value of N and/or Ns while the UE is in an RRC_CONNECTED state. The CN/AMF may send this to the gNB for idle/inactive UEs to assist the gNB to determine the PF/PO.

Although FIG. 14 illustrates one example of a method 1400 for bundling paging occasions, various changes may be made to FIG. 14. For example, while shown as a series of steps, various steps in FIG. 14 could overlap, occur in parallel, occur in a different order, occur any number of times, be omitted, or replaced by other steps.

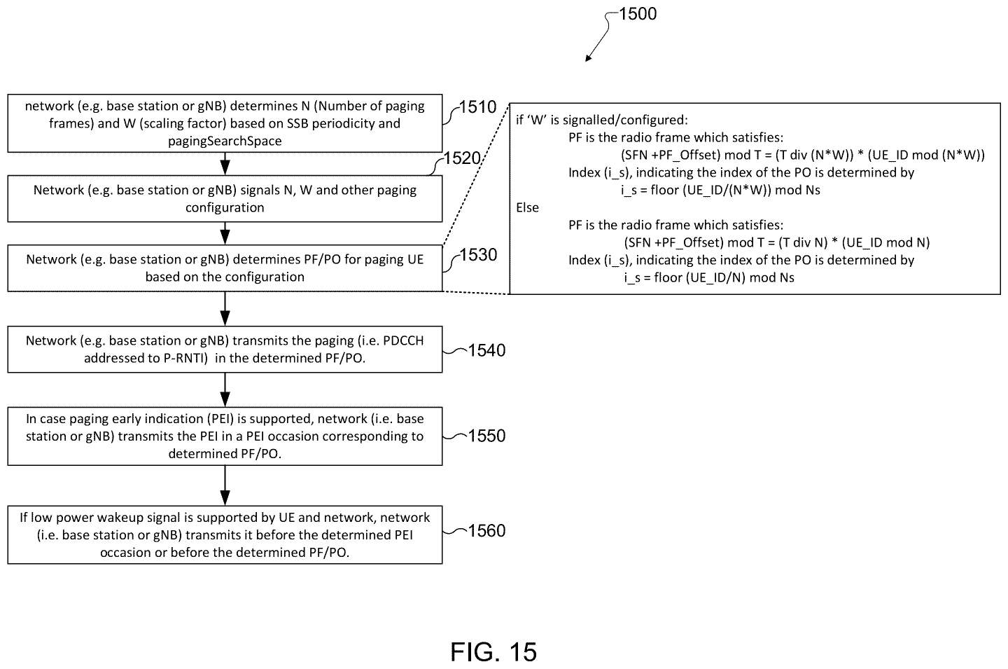

FIG. 15 illustrates a method 1500 for paging a UE according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments for paging a UE could be used without departing from the scope of this disclosure.

In the example of FIG. 15, the method begins at step 1510. At step 1510, a network element (e.g., base station or gNB) determines N (number of paging frames) and W (scaling factor) based on the SSB periodicity and pagingSearchSpace.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3): 1) the network element (e.g., base station or gNB) sets parameter N to oneSixteenthT (i.e., nAndPagingFrameOffset is set to oneSixteenthT). 2) The network element (e.g., base station or gNB) signals scaling factor ‘W’. W is set to one of ½, ¼, ⅛ . . . , etc. based on the SSB periodicity; if the SSB periodicity is 320 ms, W is set to 1/2; if the SSB periodicity is 640 ms, W is set to 1/4, etc.; in one embodiment W is set to 160/SSB periodicity. 3) SSB periodicity can be indicated by the field ssb-periodicityServingCell in system information (e.g., SIB1 or SIB).

If the SSB periodicity is <=160 ms and pagingSearchSpace is zero:
If the SS/PBCH block and CORESET multiplexing pattern is 2 or 3, for an SSB periodicity of 5 or 10 ms, N can be set to one of {oneT, halfT quarterT, oneEighthT, oneSixteenthT}. For an SSB periodicity of 20 ms, N can be set to one of {halfT, quarterT, oneEighthT, oneSixteenthT}. For an SSB periodicity of 40 ms, N can be set to one of {quarterT oneEighthT, oneSixteenthT}. For an SSB periodicity of 80 ms, N can be set to one of {oneEighthT, oneSixteenthT}. For an SSB periodicity of 160 ms, N can be set to oneSixteenthT.

If the SS/PBCH block and CORESET multiplexing pattern is 1, N can be set to one of {halfT, quarterT, oneEighthT oneSixteenthT}. The network element (e.g., base station or gNB) may skip to signal ‘W’ or it can set ‘W’ to 1. The SSB periodicity can be indicated by the field ssb-periodicityServingCell in system information (e.g., SIB1 or SIB).

At step 1520, the network element (e.g., base station or gNB) may signal N, W and other paging configurations (such as pagingSearchSpace, Ns, default DRX cycle etc.). The signaling can be via system information (such as SIB or SIB1), or RRC message or SI message or any other message.

At step 1530, the network element (e.g., base station or gNB) determines the PF/PO for paging the UE. If there is paging for the UE, network determines the PF/PO for paging the UE as follows:

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3) (alternately, if ‘W’ is signaled/configured):

The PF is the radio frame (SFN) which satisfies:

$$( SFN + PF\_Offset ) mod T = ( T div ( N ⋆ W ) ) ⋆ ( UE\_ID mod ( N ⋆ W ) ) .$$

The index (i_s), indicating the index of the PO is determined by: i_s=floor (UE_ID/(N*W)) mod Ns.

Otherwise, the PF is the radio frame (SFN) which satisfies:

$$( SFN + PF\_Offset ) mod T = ( T div N ) ⋆ ( UE\_ID mod N ) .$$

The index (i_s), indicating the index of the PO is determined by:

$$i\_s = floor ( UE\_ID / N ) mod Ns .$$

Alternately, if there is paging for the UE, the network element determines the PF/PO for paging the UE as follows:

The PF is the radio frame (SFN) which satisfies:

$$( SFN + PF\_Offset ) mod T = ( T div ( N ⋆ W ) ) ⋆ ( UE\_ID mod ( N ⋆ W ) ) .$$

The index (i_s), indicating the index of the PO is determined by:

$$i\_s = floor ( UE\_ID / ( N ⋆ W ) ) mod Ns .$$

W equals 1, if not signaled/configured.

UE_ID can be 5G-S-TMSI mod Y where Y can be 1024, 2048, 4096, 8192, 16384, etc.

At step 1540, the network element (e.g., base station or gNB) transmits the paging (i.e., PDCCH addressed to P-RNTI) in the determined PF/PO.

At step 1550, in case paging early indication (PEI) is supported, the network element (i.e., base station or gNB) transmits the PEI in a PEI occasion corresponding to determined PF/PO.

At step 1560, if a low power wakeup signal is supported by the UE and the network, the network element (e.g., base station or gNB) transmits the low power wakeup signal before the determined PEI occasion or before the determined PF/PO.

Although FIG. 15 illustrates one example of a method 1500 for paging a UE, various changes may be made to FIG. 15. For example, while shown as a series of steps, various steps in FIG. 15 could overlap, occur in parallel, occur in a different order, occur any number of times, be omitted, or replaced by other steps.

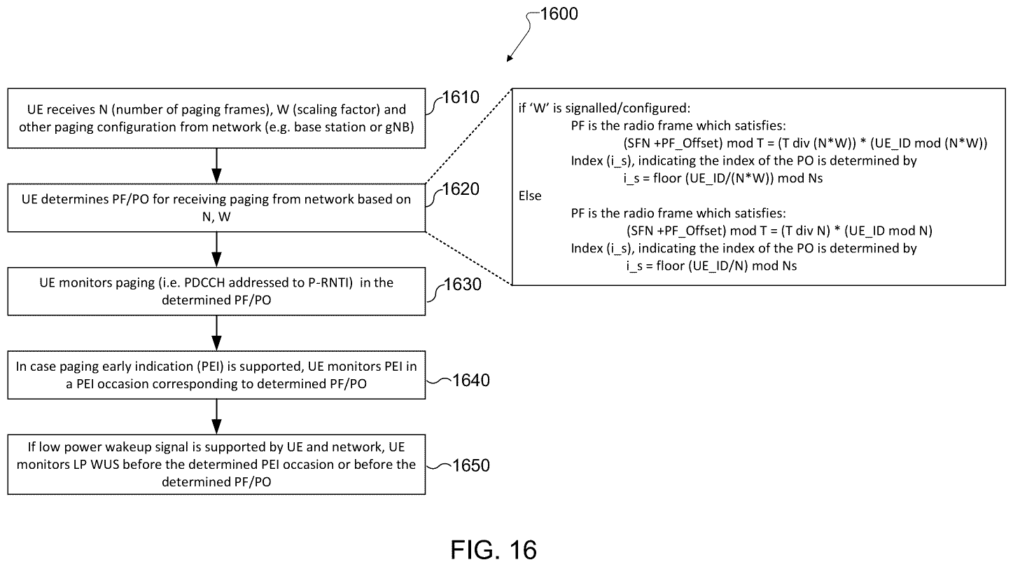

FIG. 16 illustrates a method 1600 for receiving paging according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments for receiving paging could be used without departing from the scope of this disclosure.

In the example of FIG. 16, the method begins at step 1610. At step 1610, a UE may receive N, W and other paging configurations (such as pagingSearchSpace, Ns, default DRX cycle, PF_Offset, SSB periodicity etc.) from a network element (e.g., base station or gNB). These can be received in system information (such as SIB or SIB1), or an RRC message or SI message or any other message.

At step 1620, the UE determines the PF/PO for receiving paging based on received configuration as follows:

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3) (alternately, if ‘W’ is signaled/configured):

The PF is the radio frame (SFN) which satisfies:

$$( SFN + PF\_Offset ) mod T = ( T div ( N ⋆ W ) ) ⋆ ( UE\_ID mod ( N ⋆ W ) ) .$$

The index (i_s), indicating the index of the PO is determined by:

$$i\_s = floor ( UE\_ID / ( N ⋆ W ) ) mod Ns .$$

Otherwise, the PF is the radio frame (SFN) which satisfies:

$$( SFN + PF\_Offset ) mod T = ( T div N ) ⋆ ( UE\_ID mod N ) .$$

The index (i_s), indicating the index of the PO is determined by

$$i\_s = floor ( UE\_ID / N ) mod Ns .$$

Alternately, the UE determines the PF/PO for receiving paging based on received configuration as follows:

The PF is the radio frame (SFN) which satisfies:

$$( SFN + PF\_Offset ) mod T = ( T div ( N ⋆ W ) ) ⋆ ( UE\_ID mod ( N ⋆ W ) ) .$$

The index (i_s), indicating the index of the PO is determined by:

$$i\_s = floor ( UE\_ID / ( N ⋆ W ) ) mod Ns$$

W equals 1, if not signaled/configured.

UE_ID can be 5G-S-TMSI mod Y where Y can be 1024, 2048, 4096, 8192, 16384, etc.

At step 1630, the UE monitors paging (i.e., PDCCH addressed to P-RNTI) in the determined PF/PO.

At step 1640, in case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

At step 1650, If a low power wakeup signal is supported by the UE and the network, the UE monitors for an LP WUS before the determined PEI occasion or before the determined PF/PO. If the LP WUS is received (or an LP WUS for UE/UE specific paging subgroup is received), the UE monitors for a PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

Although FIG. 16 illustrates one example of a method 1600 for receiving paging, various changes may be made to FIG. 16. For example, while shown as a series of steps, various steps in FIG. 16 could overlap, occur in parallel, occur in a different order, occur any number of times, be omitted, or replaced by other steps.

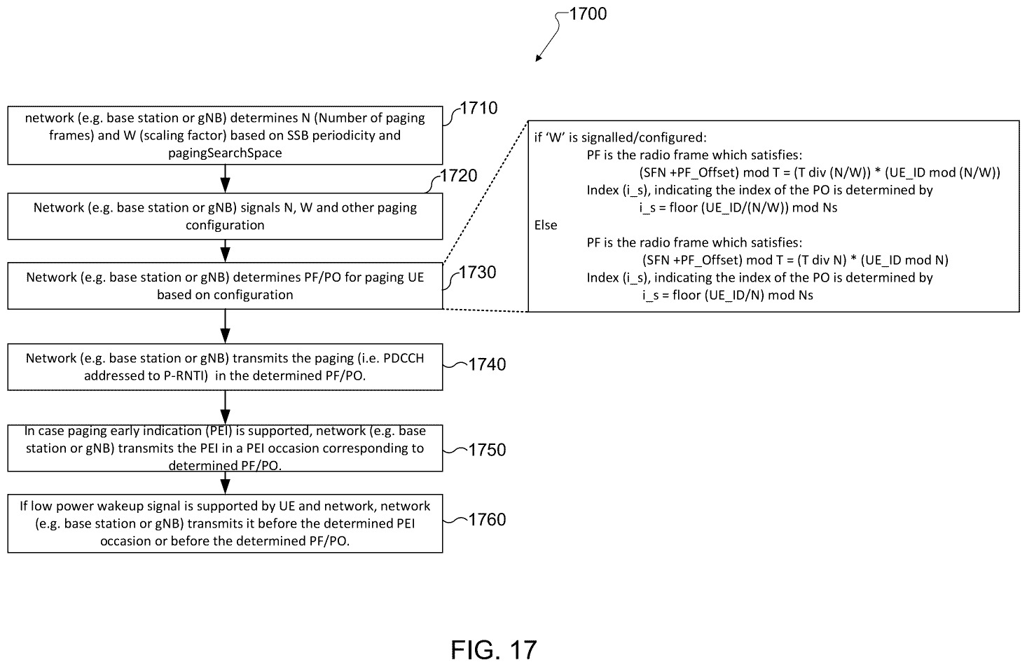

FIG. 17 illustrates another method 1700 for paging a UE according to embodiments of the present disclosure. An embodiment of the method illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments for paging a UE could be used without departing from the scope of this disclosure.

In the example of FIG. 17, the method begins at step 1710. At step 1710 a network element (e.g., base station or gNB) determines N (number of paging frames) and W (scaling factor) based on the SSB periodicity and pagingSearchSpace.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3), the network element (e.g., base station or gNB) sets parameter N to oneSixteenthT (i.e., nAndPagingFrameOffset is set to oneSixteenthT). The network element (e.g., base station or gNB) signals a scaling factor ‘W’. W is set to one of 2, 4, 8 . . . , etc. based on the SSB periodicity. If the SSB periodicity is 320 ms, W is set to 2; If the SSB periodicity is 640 ms, W is set to 4, etc. In one embodiment W is set to SSB periodicity/160. The SSB periodicity can be indicated by the field ssb-periodicityServingCell in system information (e.g., SIB1 or SIB).

If the SSB periodicity is <=160 ms and pagingSearchSpace is zero:

If the SS/PBCH block and CORESET multiplexing pattern is 2 or 3, for an SSB periodicity of 5 or 10 ms, N can be set to one of {oneT, halfT quarterT, oneEighthT, oneSixteenthT}. For an SSB periodicity of 20 ms, N can be set to one of {halfT, quarterT, oneEighthT, oneSixteenthT}. For an SSB periodicity of 40 ms, N can be set to one of {quarterT oneEighthT, oneSixteenthT}. For an SSB periodicity of 80 ms, N can be set to one of {oneEighthT, oneSixteenthT}. For an SSB periodicity of 160 ms, N can be set to oneSixteenthT.

If the SS/PBCH block and CORESET multiplexing pattern is 1, N can be set to one of {halfT, quarterT, oneEighthT, oneSixteenthT}.

The network element may skip to signal ‘W’, or it can set ‘W’ to 1.

The SSB periodicity can be indicated by the field ssb-periodicityServingCell in system information (e.g., SIB1 or SIB).

At step 1720, the network element (e.g., base station or gNB) may signal N, W and other paging configurations (such as pagingSearchSpace, Ns, default DRX cycle etc.). The signaling can be via system information (such as SIB or SIB1), or an RRC message or SI message or any other message.

At step 1730 the network element (e.g., base station or gNB) determines the PF/PO for paging UE based on configuration as follows.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3) (alternately, if ‘W’ is signaled/configured):

The PF is the radio frame (SFN) which satisfies:

$$( SFN + PF\_Offset ) mod T = ( T div ( N / W ) ) ⋆ ( UE\_ID mod ( N / W ) ) .$$

The index (i_s), indicating the index of the PO is determined by:

$$i\_s = floor ( UE\_ID / ( N / W ) ) mod Ns .$$

Otherwise, the PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

Alternately, if there is paging for the UE, the network element determines the PF/PO for paging the UE as follows:

The PF is the radio frame (SFN) which satisfies:

$$( SFN + PF\_Offset ) mod T = ( T div ( N / W ) ) * ( UE\_ID mod ( N / W ) ) .$$

The index (i_s), indicating the index of the PO is determined by:

$$i\_s = floor ( UE\_ID / ( N / W ) ) mod Ns .$$

W equals 1, if not signaled/configured.

UE_ID can be 5G-S-TMSI mod Y where Y can be 1024, 2048, 4096, 8192, 16384, etc.

At step 1740 the network element (e.g., base station or gNB) transmits the paging (i.e., PDCCH addressed to P-RNTI) in the determined PF/PO.

At step 1750, in case paging early indication (PEI) is supported, the network element (e.g., base station or gNB) transmits a PEI in a PEI occasion corresponding to determined PF/PO.

At step 1760, if a low power wakeup signal is supported by the UE and the network, the network element (e.g., base station or gNB) transmits the low power wakeup signal before the determined PEI occasion or before the determined PF/PO.

Although FIG. 17 illustrates one example of a method 1700 for paging a UE, various changes may be made to FIG. 17. For example, while shown as a series of steps, various steps in FIG. 17 could overlap, occur in parallel, occur in a different order, occur any number of times, be omitted, or replaced by other steps.

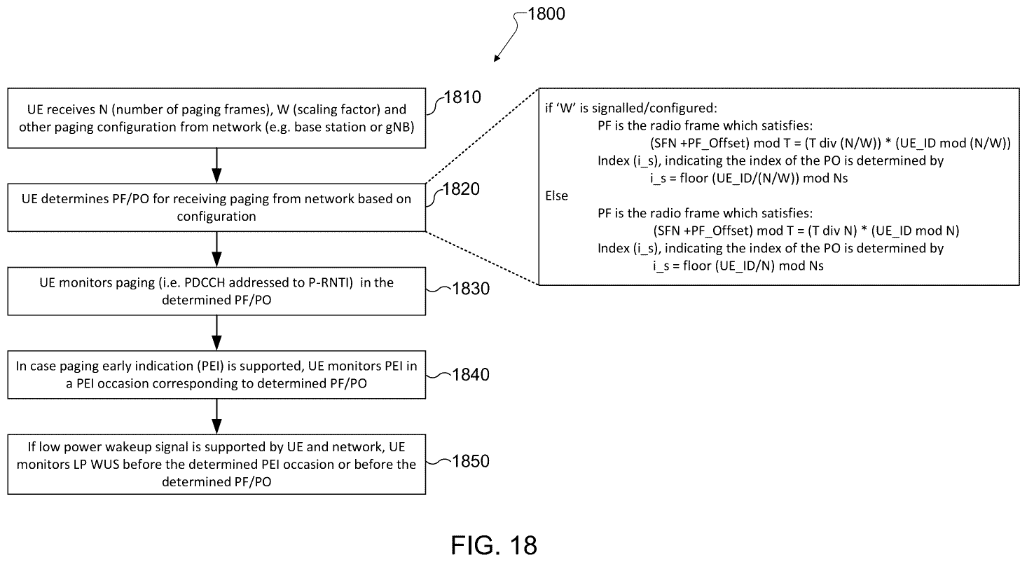

FIG. 18 illustrates another method 1800 for receiving paging according to embodiments of the present disclosure. An embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments for receiving paging could be used without departing from the scope of this disclosure.

In the example of FIG. 18, the method begins at step 1810. At step 1810 a UE may receive N, W and other paging configurations (such as pagingSearchSpace, Ns, default DRX cycle, PF_Offset, SSB periodicity etc.) from a network element (e.g., base station or gNB). These can be received in system information (such as SIB or SIB1), or an RRC message or SI message or any other message.

At step 1820, the UE determines the PF/PO for receiving paging based on received configuration as follows:

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3) (alternately, if ‘W’ is signaled/configured):

The PF is the radio frame (SFN) which satisfies:

$$( SFN + PF\_Offset ) mod T = ( T div ( N / W ) ) * ( UE\_ID mod ( N / W ) ) .$$

The index (i_s), indicating the index of the PO is determined by:

$$i\_s = floor ( UE\_ID / ( NW ) ) mod Ns .$$

Otherwise, the PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

Alternately, the UE determines the PF/PO for receiving paging based on received configuration as follows:

The PF is the radio frame (SFN) which satisfies:

$$( SFN + PF\_Offset ) mod T = ( T div ( N / W ) ) * ( UE\_ID mod ( N / W ) ) .$$

Index (i_s), indicating the index of the PO is determined by:

$$i\_s = floor ( UE\_ID / ( N / W ) ) ) mod Ns .$$

W equals 1, if not signaled/configured.

UE_ID can be 5G-S-TMSI mod Y where Y can be 1024, 2048, 4096, 8192, 16384, etc.

At step 1830, the UE monitors paging (i.e., PDCCH addressed to P-RNTI) in the determined PF/PO.

At step 1840, in case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

At step 1850, if a low power wakeup signal is supported by UE and network, the UE monitors for a LP WUS before the determined PEI occasion or before the determined PF/PO. If the LP WUS is received (or an LP WUS for UE/UE specific paging subgroup is received), the UE monitors for a PEI (using MR) and/or subsequently the UE monitors the determined PO (using MR) and receives a paging message if the PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

Although FIG. 18 illustrates one example of a method 1800 for receiving paging, various changes may be made to FIG. 18. For example, while shown as a series of steps, various steps in FIG. 18 could overlap, occur in parallel, occur in a different order, occur any number of times, be omitted, or replaced by other steps.

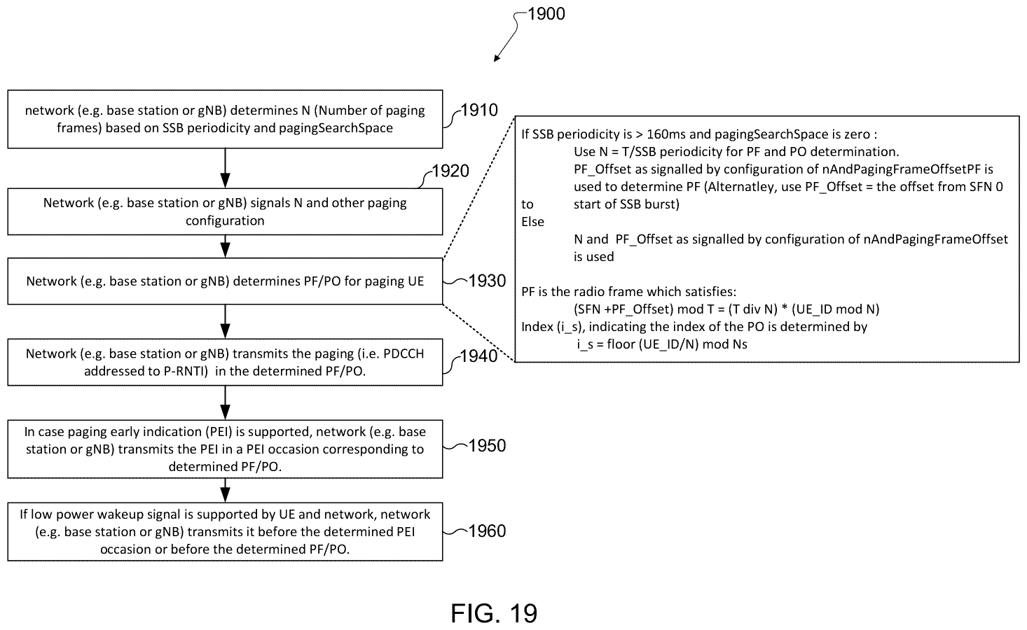

FIG. 19 illustrates another method 1900 for paging a UE according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments for paging a UE could be used without departing from the scope of this disclosure.

In the example of FIG. 19, the method begins at step 1910. At step 1910, a network element (e.g., base station or gNB) determines N (Number of paging frames) based on the SSB periodicity and pagingSearchSpace.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3), the network element (i.e., base station or gNB) sets parameter N to oneSixteenthT (i.e., nAndPagingFrameOffset is set to oneSixteenthT). The network element also sets the paging frame offset. The SSB periodicity can be indicated by the field ssb-periodicityServingCell in system information (e.g., SIB1 or SIB).

If the SSB periodicity is <=160 ms and pagingSearchSpace is zero:

If the SS/PBCH block and CORESET multiplexing pattern is 2 or 3, for an SSB periodicity of 5 or 10 ms, N can be set to one of {oneT, halfT, quarterT, oneEighthT, oneSixteenthT}. For an SSB periodicity of 20 ms, N can be set to one of {halfT, quarterT, oneEighthT, oneSixteenthT} For an SSB periodicity of 40 ms, N can be set to one of {quarterT oneEighthT, oneSixteenthT}. For an SSB periodicity of 80 ms, N can be set to one of {oneEighthT, oneSixteenthT}. For an SSB periodicity of 160 ms, N can be set to oneSixteenthT.

If the SS/PBCH block and CORESET multiplexing pattern is 1, N can be set to one of {halfT, quarterT, oneEighthT, oneSixteenthT}.

The SSB periodicity can be indicated by the field ssb-periodicityServingCell in system information (e.g., SIB1 or SIB).

At step 1920, the network element (e.g., base station or gNB) may signal N and other paging configurations (such as pagingSearchSpace, Ns, default DRX cycle etc.). The signaling can be via system information (such as SIB or SIB1), or an RRC message or SI message or any other message.

At step 1930, the network element (e.g., base station or gNB) determines the PF/PO for paging UE as follows.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3), N=T/SSB periodicity is used for PF and PO determination. N as signaled by configuration of nAndPagingFrameOffset is not used. PF_Offset as signaled by configuration of nAndPagingFrameOffsetPF is used to determine PF (alternately, use PF_Offset=the offset from SFN 0 to start of SSB burst).

Otherwise, N and PF_Offset as signaled by configuration of nAndPagingFrameOffset is used.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 1940, the network element (e.g., base station or gNB) transmits the paging (i.e., PDCCH addressed to P-RNTI) in the determined PF/PO.

At step 1950, in case paging early indication (PEI) is supported, the network element (e.g., base station or gNB) transmits a PEI in a PEI occasion corresponding to determined PF/PO.

At step 1960, if a low power wakeup signal is supported by the UE and the network, the network element (e.g., base station or gNB) transmits the low power wakeup signal before the determined PEI occasion or before the determined PF/PO.

Although FIG. 19 illustrates one example of a method 1900 for paging a UE, various changes may be made to FIG. 19. For example, while shown as a series of steps, various steps in FIG. 19 could overlap, occur in parallel, occur in a different order, occur any number of times, be omitted, or replaced by other steps.

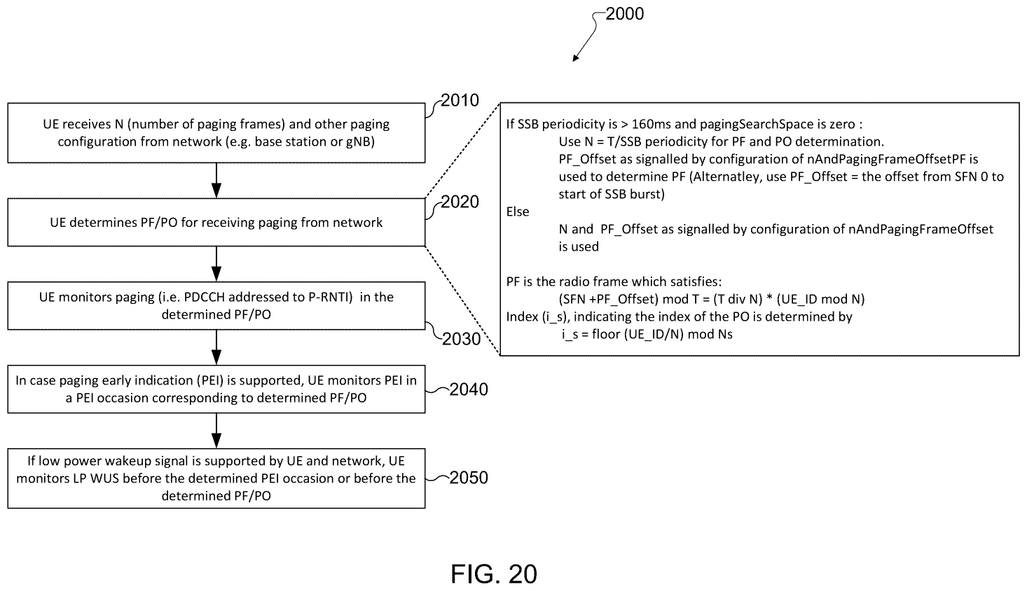

FIG. 20 illustrates another method 2000 for receiving paging according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments for receiving paging could be used without departing from the scope of this disclosure.

In the example of FIG. 20, the method begins at step 2010. At step 2010, a UE may receive N and other paging configurations (such as pagingSearchSpace, Ns, default DRX cycle, PF_Offset, SSB periodicity etc.) from a network element (e.g., base station or gNB). These can be received in system information (such as SIB or SIB1), or an RRC message or SI message or any other message.

At step 2020, the UE determines the PF/PO for receiving paging based on received configuration as follows:

If the SSB periodicity is >160 ms and pagingSearchSpace is zero (alternately, if the SSB periodicity is >160 ms and pagingSearchSpace is zero and if SS/PBCH block and CORESET multiplexing pattern is 2 or 3), N=T/SSB periodicity is used for PF and PO determination. N as signaled by configuration of nAndPagingFrameOffset is not used. PF_Offset as signaled by configuration of nAndPagingFrameOffsetPF is used to determine PF (alternately, use PF_Offset=the offset from SFN 0 to start of SSB burst).

Otherwise, N and PF_Offset as signaled by configuration of nAndPagingFrameOffset is used.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2030, the UE monitors paging (i.e., PDCCH addressed to P-RNTI) in the determined PF/PO.

At step 2040, In case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

At step 2050, if a low power wakeup signal is supported by the UE and the network, the UE monitors for a LP WUS before the determined PEI occasion or before the determined PF/PO. If the LP WUS is received (or an LP WUS for UE/UE specific paging subgroup is received), the UE monitors for a PEI (using MR) and/or subsequently the UE monitors the determined PO (using MR) and receives a paging message if a PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

Although FIG. 20 illustrates one example of a method 2000 for receiving paging, various changes may be made to FIG. 20. For example, while shown as a series of steps, various steps in FIG. 20 could overlap, occur in parallel, occur in a different order, occur any number of times, be omitted, or replaced by other steps.

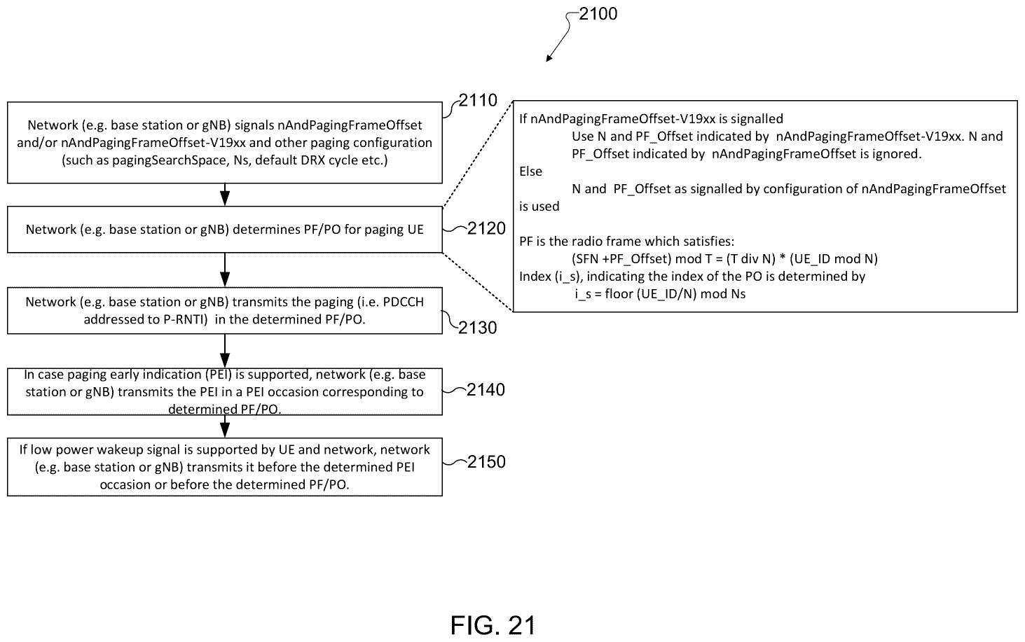

FIG. 21 illustrates another method 2100 for paging a UE according to embodiments of the present disclosure. An embodiment of the method illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments for paging a UE could be used without departing from the scope of this disclosure.

In the example of FIG. 21, the method begins at step 2110. At step 2110, a network element (e.g., base station or gNB) signals nAndPagingFrameOffset and/or nAndPagingFrameOffset-V19xx and other paging configurations (such as pagingSearchSpace, Ns, default DRX cycle etc.). The signaling can be via system information (such as SIB or SIB1), or an RRC message or SI message or any other message.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3) (alternately, if the SSB periodicity is >160 ms), N is set to T/SSB periodicity. The network signals N and PF_Offset by including the parameter nAndPagingFrameOffset-V19xx in the paging configuration

| | |
|---|---|
| nAndPagingFrameOffset-V19xx | CHOICE { |
| oneThirtytwothT | INTEGER (0..31), |
| oneSixtyFourthT | INTEGER (0..63), |
| oneOneTwentyeighthT | INTEGER (0..127), |
| } | |

If the SSB periodicity is 320 ms, N is set to oneThirtytwothT; if the SSB periodicity is 640 ms, N is set to oneSixtyFourthT; if the SSB periodicity is 1280 ms, N is set to oneOneTwentyeighthT; etc.

If the SSB periodicity is <=160 ms and pagingSearchSpace is zero:

If the SS/PBCH block and CORESET multiplexing pattern is 2 or 3, For an SSB periodicity of 5 or 10 ms, N can be set to one of {oneT, halfT quarterT, oneEighthT, oneSixteenthT}. For an SSB periodicity of 20 ms, N can be set to one of {halfT, quarterT, oneEighthT, oneSixteenthT}. For an SSB periodicity of 40 ms, N can be set to one of {quarterT oneEighthT, oneSixteenthT}. For an SSB periodicity of 80 ms, N can be set to one of {oneEighthT, oneSixteenthT}. For an SSB periodicity of 160 ms, N can be set to oneSixteenthT.

If the SS/PBCH block and CORESET multiplexing pattern is 1, N can be set to one of {halfT, quarterT, oneEighthT, oneSixteenthT}

The network element signals N and PF_Offset by including the parameter nAndPagingFrameOffset in the paging configuration

| | |
|---|---|
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |
| }, | |

If the SSB periodicity is <=160 ms and pagingSearchSpace is nonzero, the network signals N and PF_Offset by including the parameter nAndPagingFrameOffset in the paging configuration

| | |
|---|---|
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |
| }, | |

At step 2120, the network element (e.g., base station or gNB) determines the PF/PO for paging UE as follows.

If nAndPagingFrameOffset-V19xx is signaled, N and PF_Offset indicated by nAndPagingFrameOffset-V19xx is used. N and PF_Offset indicated by nAndPagingFrameOffset is ignored.

Otherwise, N and PF_Offset as signaled by configuration of nAndPagingFrameOffset is used.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2130, the network element (e.g., base station or gNB) transmits the paging (i.e., PDCCH addressed to P-RNTI) in the determined PF/PO.

At step 2140, in case paging early indication (PEI) is supported, the network element (e.g., base station or gNB) transmits a PEI in a PEI occasion corresponding to the determined PF/PO.

At step 2150, if a low power wakeup signal is supported by the UE and the network, the network element (e.g., base station or gNB) transmits a low power wakeup signal before the determined PEI occasion or before the determined PF/PO.

Although FIG. 21 illustrates one example of a method 2100 for paging a UE, various changes may be made to FIG. 21. For example, while shown as a series of steps, various steps in FIG. 21 could overlap, occur in parallel, occur in a different order, occur any number of times, be omitted, or replaced by other steps.

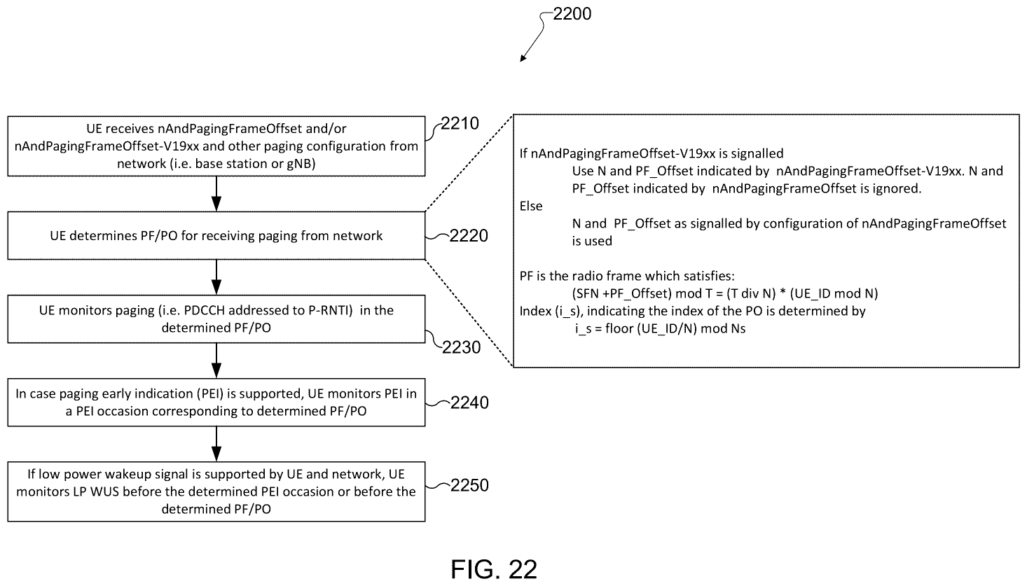

FIG. 22 illustrates another method 2200 for receiving paging according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments for receiving paging could be used without departing from the scope of this disclosure.

In the example of FIG. 22, the method begins at step 2210. At step 2210, a UE receives nAndPagingFrameOffset and/or nAndPagingFrameOffset-V19xx and other paging configurations (such as pagingSearchSpace, Ns, default DRX cycle etc.) from a network element (e.g., base station or gNB). These can be received in system information (such as SIB or SIB1), or an RRC message or SI message or any other message.

At step 2220, the UE determines the PF/PO for receiving paging based on received configuration as follows:

If nAndPagingFrameOffset-V19xx is signaled, N and PF_Offset indicated by nAndPagingFrameOffset-V19xx is used. N and PF_Offset indicated by nAndPagingFrameOffset is ignored.

Otherwise, N and PF_Offset as signaled by configuration of nAndPagingFrameOffset is used.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2230, UE monitors paging (i.e., PDCCH addressed to P-RNTI) in the determined PF/PO.

At step 2240, in case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

At step 2250, If a low power wakeup signal is supported by the UE and the network, the UE monitors for an LP WUS before the determined PEI occasion or before the determined PF/PO. If the LP WUS is received (or an LP WUS for the UE/UE specific paging subgroup is received), the UE monitors for a PEI (using MR) and/or subsequently the UE monitors the determined PO (using MR) and receives a paging message if a PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

Although FIG. 22 illustrates one example of a method 2200 for receiving paging, various changes may be made to FIG. 22. For example, while shown as a series of steps, various steps in FIG. 22 could overlap, occur in parallel, occur in a different order, occur any number of times, be omitted, or replaced by other steps.

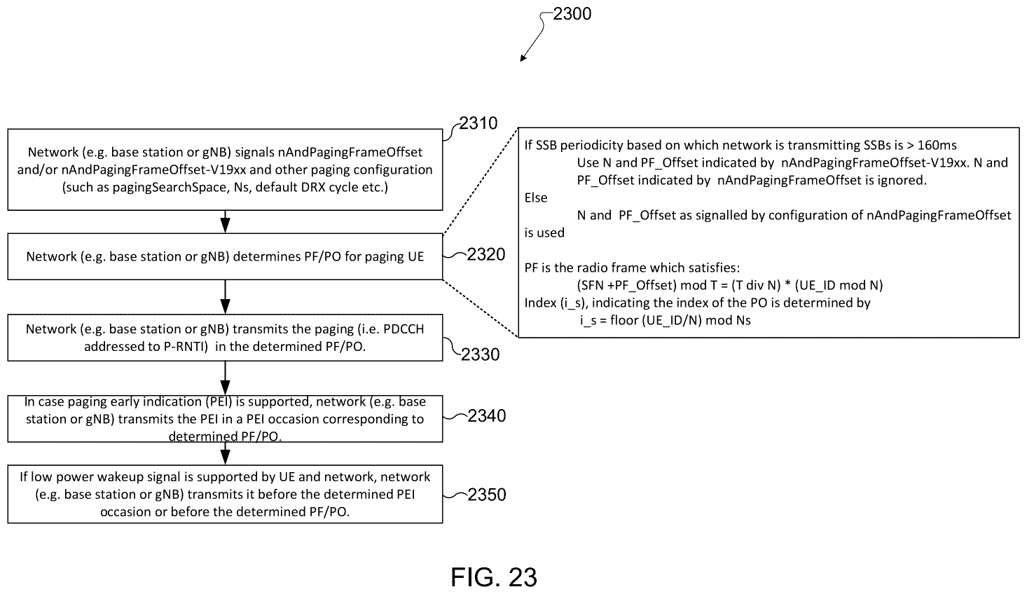

FIG. 23 illustrates another method 2300 for paging a UE according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments for paging a UE could be used without departing from the scope of this disclosure.

In the example of FIG. 23, the method begins at step 2310. At step 2310, a network element (e.g., base station or gNB) signals nAndPagingFrameOffset and/or nAndPagingFrameOffset-V19xx and other paging configurations (such as pagingSearchSpace, Ns, default DRX cycle etc.). The signaling can be via system information (such as SIB or SIB1), or an RRC message or SI message or any other message.

nAndPagingFrameOffset-V19xx indicates N and PF_offset for SSB periodicity>160 ms

| | |
|---|---|
| nAndPagingFrameOffset-V19xx | CHOICE { |
| oneThirtytwothT | INTEGER (0..31), |
| oneSixtyFourthT | INTEGER (0..63), |
| oneOneTwentyeighthT | INTEGER (0..127), |
| } | |

If the SSB periodicity is 320 ms, N is set to oneThirtytwothT; If the SSB periodicity is 640 ms, N is set to oneSixtyFourthT; If the SSB periodicity is 1280 ms, N is set to oneOneTwentyeighthT; etc.
nAndPagingFrameOffset indicates N and PF_offset for SSB periodicity<=160 ms

| | |
|---|---|
| - nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |
| } | |

At step 2330, the network element (e.g., base station or gNB) determines the PF/PO for paging UE as follows:

If the SSB periodicity based on which the network is transmitting SSBs is >160 ms (or alternately if the SSB periodicity based on which the network is transmitting SSBs is >160 ms and pagingSearchSpace is zero and if the SS/PBCH block and CORESET multiplexing pattern is 2 or 3) (or alternately If the SSB periodicity based on which the network is transmitting SSBs is >160 ms and pagingSearchSpace is zero), N and PF_Offset indicated by nAndPagingFrameOffset-V19xx is used to determine the PF/PO.

Otherwise, N and PF_Offset indicated by nAndPagingFrameOffset is used to determine the PF/PO.

The PF is the radio frame (SFN) which satisfies:

$$( SFN + PF\_Offset ) mod T = ( T div N ) * ( UE\_ID mod N ) .$$

The Index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2330, the network element (e.g., base station or gNB) transmits the paging (i.e., PDCCH addressed to P-RNTI) in the determined PF/PO.

At step 2340, in case paging early indication (PEI) is supported, the network element (e.g., base station or gNB) transmits a PEI in a PEI occasion corresponding to the determined PF/PO.

At step 2350, if a low power wakeup signal is supported by the UE and the network, the network element (i.e., base station or gNB) transmits a low power wakeup signal before the determined PEI occasion or before the determined PF/PO.

In one embodiment, the network element can signal two SSB periodicities: a short SSB periodicity and a longer SSB periodicity. N and PF_Offset corresponding to each of these SSB periodicities may be separately signaled. If not, the UE/gNB apply the same N and PF_Offset for both SSB periodicities. The SSB periodicity can be dynamically updated between the shorter and longer periodicity and the network entity indicates (e.g., using a PDCCH or a short message or a paging message or a paging DCI or system information) which of the two SSB periodicities to apply. In one embodiment, upon receiving an indication to change the SSB periodicity, the changed periodicity and corresponding configuration of N and PF_offset is applied from the current DRX cycle/default DRX cycle or from the next DRX cycle/default DRX cycle or from a specified DRX cycle/default DRX cycle. In one embodiment, upon receiving an indication to change the SSB periodicity, the changed periodicity and corresponding configuration of N and PF_offset is applied from the end of the SSB period corresponding to the current SSB periodicity. In one embodiment upon receiving the SSB periodicity change indication, the SSBs based on the changed SSB periodicity are transmitted after the end of the SSB period corresponding to the SSB periodicity before the change. In one embodiment upon receiving the SSB periodicity change indication, the SSBs are transmitted in SSB occasions based on the changed SSB periodicity.

Although FIG. 23 illustrates one example of a method 2300 for paging a UE, various changes may be made to FIG. 23. For example, while shown as a series of steps, various steps in FIG. 23 could overlap, occur in parallel, occur in a different order, occur any number of times, be omitted, or replaced by other steps.

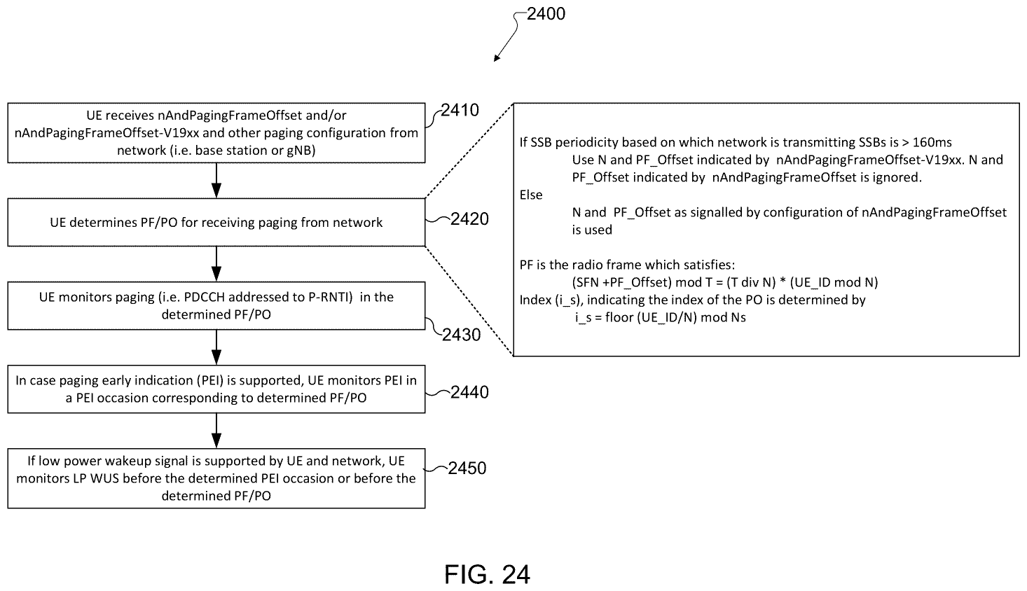

FIG. 24 illustrates another method 2400 for receiving paging according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments for receiving paging could be used without departing from the scope of this disclosure.

In the example of FIG. 24, the method begins at step 2410. At step 2410, a UE may receive nAndPagingFrameOffset and/or nAndPagingFrameOffset-V19xx and other paging configurations (such as pagingSearchSpace, Ns, default DRX cycle etc.) from a network entity (i.e., base station or gNB). These can be received in system information (such as SIB or SIB1), or an RRC message or SI message or any other message.

At step 2420, the UE determines the PF/PO for receiving paging based on received configuration as follows:

If the SSB periodicity based on which the network is transmitting SSBs is >160 ms (or alternately If the SSB periodicity based on which the network is transmitting SSBs is >160 ms and pagingSearchSpace is zero and if the SS/PBCH block and CORESET multiplexing pattern is 2 or 3) (or alternately If the SSB periodicity based on which the network is transmitting SSBs is >160 ms and pagingSearchSpace is zero), N and PF_Offset indicated by nAndPagingFrameOffset-V19xx is used to determine the PF/PO.

Otherwise, N and PF_Offset indicated by nAndPagingFrameOffset is used to determine the PF/PO.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2430, the UE monitors paging (i.e., PDCCH addressed to P-RNTI) in the determined PF/PO.

At step 2440, in case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

At step 2450, if a low power wakeup signal is supported by the UE and the network, the UE monitors for an LP WUS before the determined PEI occasion or before the determined PF/PO. If the LP WUS is received (or an LP WUS for the UE/UE specific paging subgroup is received), the UE monitors for a PEI (using MR) and/or subsequently the UE monitors the determined PO (using MR) and receives a paging message if a PEI indicates paging for UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

Although FIG. 24 illustrates one example of a method 2400 for receiving paging, various changes may be made to FIG. 24. For example, while shown as a series of steps, various steps in FIG. 24 could overlap, occur in parallel, occur in a different order, occur any number of times, be omitted, or replaced by other steps.

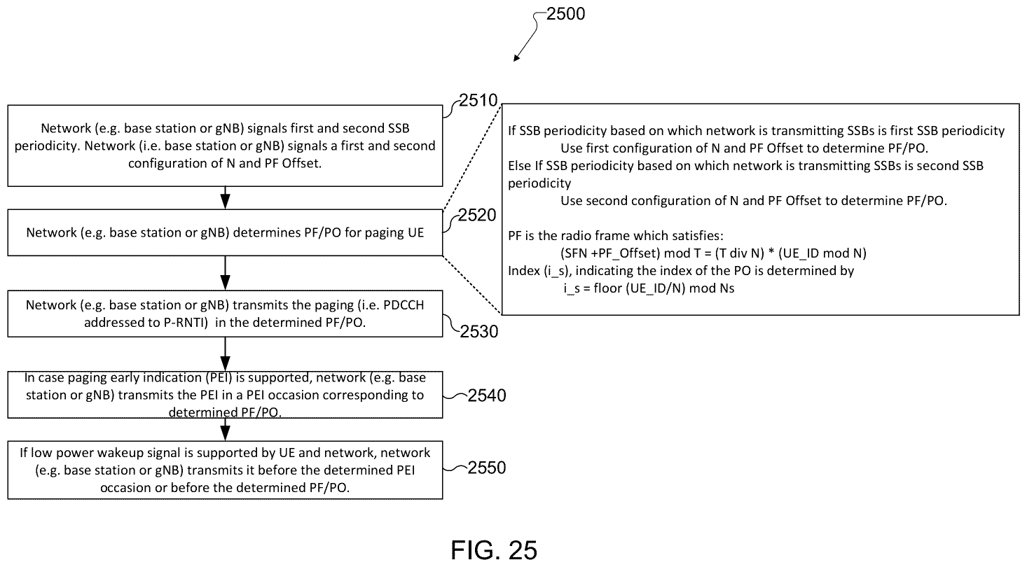

FIG. 25 illustrates another method 2500 for paging a UE according to embodiments of the present disclosure. An embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments for paging a UE could be used without departing from the scope of this disclosure.

In the example of FIG. 25, the method begins at step 2510. At step 2510, a network element (e.g., base station or gNB) signals a first and second SSB periodicity. The network element (e.g., base station or gNB) signals a first and second configuration of N and PF Offset. The first configuration of N and PF Offset corresponds to the first SSB periodicity. The second configuration of N and PF Offset corresponds to the second SSB periodicity. Configuration of N and PF Offset can be signaled using nAndPagingFrameOffset or nAndPagingFrameOffset-V19xx. The signaling can be via system information (such as SIB or SIB1), or an RRC message or SI message or any other message.

At step 2520, The network element (e.g., base station or gNB) determines the PF/PO for paging UE as follows:

If the SSB periodicity based on which the network is transmitting SSBs is the first SSB periodicity, the first configuration of N and PF Offset is used to determine the PF/PO.

Otherwise, if the SSB periodicity based on which the network is transmitting SSBs is the second SSB periodicity, the second configuration of N and PF Offset is used to determine the PF/PO.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2530, the network element (e.g., base station or gNB) transmits the paging (i.e., PDCCH addressed to P-RNTI) in the determined PF/PO.

At step 2540, in case paging early indication (PEI) is supported, the network element (e.g., base station or gNB) transmits a PEI in a PEI occasion corresponding to determined PF/PO.

At step 2550, if a low power wakeup signal is supported by the UE and the network, the network element (e.g., base station or gNB) transmits a low power wakeup signal before the determined PEI occasion or before the determined PF/PO.

Although FIG. 25 illustrates one example of a method 2500 for paging a UE, various changes may be made to FIG. 25. For example, while shown as a series of steps, various steps in FIG. 25 could overlap, occur in parallel, occur in a different order, occur any number of times, be omitted, or replaced by other steps.

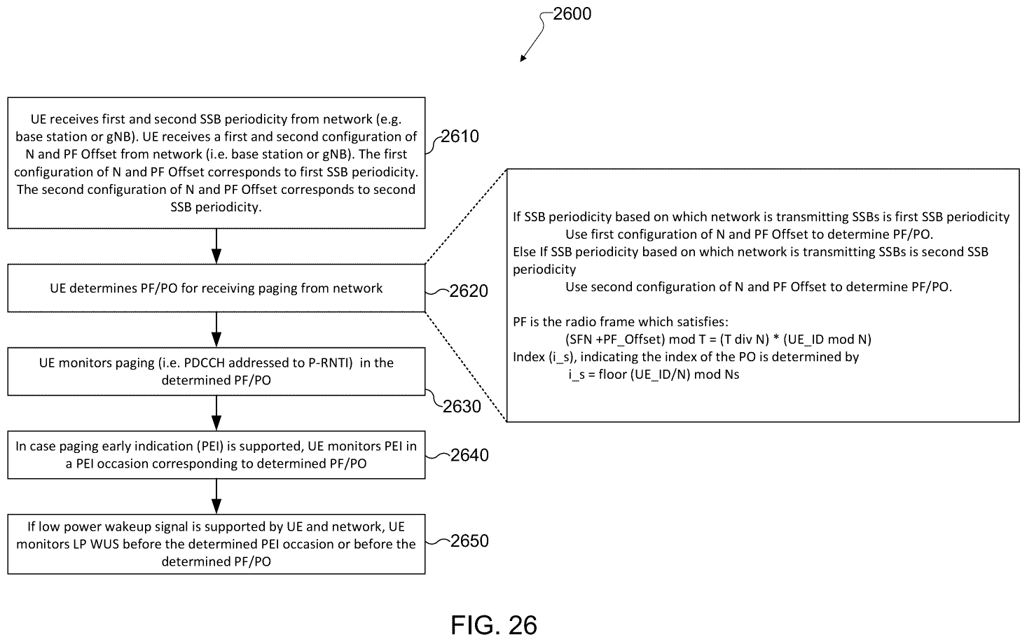

FIG. 26 illustrates another method 2600 for receiving paging according to embodiments of the present disclosure. An embodiment of the method illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments for receiving paging could be used without departing from the scope of this disclosure.

In the example of FIG. 26, the method begins at step 2610. At step 2610, a UE receives a first and second SSB periodicity from a network element (e.g., base station or gNB). The UE receives a first and second configuration of N and PF Offset from a network element (e.g., base station or gNB). The first configuration of N and PF Offset corresponds to the first SSB periodicity. The second configuration of N and PF Offset corresponds to the second SSB periodicity. Configuration of N and PF Offset can be signaled using nAndPagingFrameOffset or nAndPagingFrameOffset-V19xx. These can be received in system information (such as SIB or SIB1), or an RRC message or SI message or any other message.

At step 2620, the UE determines the PF/PO for receiving paging based on received configuration as follows:

If the SSB periodicity based on which the network is transmitting SSBs is first SSB periodicity, the first configuration of N and PF Offset is used to determine the PF/PO.

Otherwise, if the SSB periodicity based on which the network is transmitting SSBs is the second SSB periodicity, the second configuration of N and PF Offset is used to determine the PF/PO.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

At step 2630, the UE monitors paging (i.e., PDCCH addressed to P-RNTI) in the determined PF/PO.

At step 2640, in case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

At step 2650, if a low power wakeup signal is supported by the UE and the network, the UE monitors for an LP WUS before the determined PEI occasion or before the determined PF/PO. If the LP WUS is received (or an LP WUS for the UE/UE specific paging subgroup is received), the UE monitors for a PEI (using MR) and/or subsequently the UE monitors the determined PO (using MR) and receives a paging message if a PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

Although FIG. 26 illustrates one example of a method 2600 for receiving paging, various changes may be made to FIG. 26. For example, while shown as a series of steps, various steps in FIG. 26 could overlap, occur in parallel, occur in a different order, occur any number of times, be omitted, or replaced by other steps.

In one embodiment, network element (e.g., base station or gNB) determines the pagingSearchSpace based on the SSB periodicity. If the SSB periodicity is >160 ms, the network element (e.g., base station or gNB) sets pagingSearchSpace to non-zero; otherwise, it can be set to zero or non-zero. Alternately, If the SSB periodicity is >160 ms and if the SS/PBCH block and CORESET multiplexing pattern is 2 or 3, the network element (e.g., base station or gNB) sets pagingSearchSpace to non-zero. Network element (e.g., base station or gNB) signals the determined pagingSearchSpace. The signaling can be via system information (such as SIB or SIB1), or an RRC message or SI message or any other message.

In another embodiment, network element (e.g., base station or gNB) signals a first and second SSB periodicity. First SSB periodicity is >160 ms and second SSB periodicity is <=160 ms. Network element (e.g., base station or gNB) signals a first paging search space identifier and a second paging search space identifier. The first paging search space identifier indicates paging search space corresponds to first SSB periodicity. The second paging search space identifier indicates paging search space corresponds to second SSB periodicity. In one embodiment, the first paging search space identifier can be set to non-zero and the second paging search space identifier can be set to zero or non-zero. In one embodiment, the first paging search space identifier and the second paging search space identifier can be set to zero or non-zero. In case one of the paging search space identifier is not signaled, other paging search space identifier is applied for both first and second SSB periodicity.

SSB periodicity can be dynamically updated between the first and second SSB periodicity and network indicates which of the two SSB periodicities to apply. In one embodiment, upon receiving indication to change the SSB periodicity, the changed periodicity and corresponding configuration of paging search space is applied from current DRX cycle/default DRX cycle or from next DRX cycle/default DRX cycle or from a specified DRX cycle/default DRX cycle. In one embodiment, upon receiving indication to change the SSB periodicity, the changed periodicity and corresponding configuration is applied from end of SSB period corresponding to current SSB periodicity. In one embodiment upon receiving the SSB periodicity change indication, the SSBs based on changed SSB periodicity is transmitted after the end of SSB period corresponding to SSB periodicity before the change. In one embodiment upon receiving the SSB periodicity change indication, the SSBs are transmitted in SSB occasions based on changed SSB periodicity. UE and gNB applies the paging search space identifier corresponding to SSB periodicity with which SSBs are transmitted to determine the PDCCH monitoring occasions for paging.

In one embodiment, a network element (e.g., base station or gNB) operation for paging is as follows:

The Network element (e.g., base station or gNB) determines N (Number of paging frames) based on the SSB periodicity and pagingSearchSpace.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3), the network element (e.g., base station or gNB) sets parameter N to oneSixteenthT (i.e., nAndPagingFrameOffset is set to oneSixteenthT). N is the number of paging frames. The SSB periodicity can be indicated by the field ssb-periodicityServingCell in system information (e.g., SIB1 or SIB).

If the SSB periodicity is <=160 ms and pagingSearchSpace is zero (alternately, if the SSB periodicity is >160 ms and pagingSearchSpace is zero and if the SS/PBCH block and CORESET multiplexing pattern is 2 or 3):

If the SS/PBCH block and CORESET multiplexing pattern is 2 or 3, for an SSB periodicity of 5 or 10 ms, N can be set to one of {oneT, halfT quarterT, oneEighthT, oneSixteenthT}. For an SSB periodicity of 20 ms, N can be set to one of {halfT, quarterT, oneEighthT, oneSixteenthT}. For an SSB periodicity of 40 ms, N can be set to one of {quarterT oneEighthT, oneSixteenthT}. For an SSB periodicity of 80 ms, N can be set to one of {oneEighthT, oneSixteenthT}. For an SSB periodicity of 160 ms, N can be set to oneSixteenthT.

If the SS/PBCH block and CORESET multiplexing pattern is 1, N can be set to one of {halfT, quarterT, oneEighthT, oneSixteenthT}.

The SSB periodicity can be indicated by the field ssb-periodicityServingCell in system information (e.g., SIB1 or SIB).

The network element (e.g., base station or gNB) signals N and other paging configurations (such as pagingSearchSpace, Ns, default DRX cycle etc.). The signaling can be via system information (such as SIB or SIB1), or an RRC message or SI message or any other message.

The network element (e.g., base station or gNB) determines the PF/PO for paging.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3), the network element (e.g., base station or gNB) determines N and PF_Offset from the configuration of nAndPagingFrameOffset. Alternately, the network element (i.e., base station or gNB) determines N from the configuration of nAndPagingFrameOffset. PF offset=offset from SFN 0 to start of SSB burst.

Otherwise, the network element (e.g., base station or gNB) determines N and PF_Offset from the configuration of nAndPagingFrameOffset.

If the paging search space is zero (or if the paging search space is zero and if the SS/PBCH block and CORESET multiplexing pattern is 2 or 3), if the SSB periodicity>160 ms, to determine the PDCCH monitoring occasions for paging, the network entity (i.e., base station or gNB) assumes that the SSB periodicity is 160 ms.

The PF is the radio frame (SFN) which satisfies:

$$( SFN + PF\_Offset ) mod T = ( T div N ) * ( UE\_ID mod N ) .$$

The index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

The network entity (e.g., base station or gNB) transmits the paging (i.e., PDCCH addressed to P-RNTI) in the determined PF/PO.

In case paging early indication (PEI) is supported, the network entity (i.e., base station or gNB) transmits a PEI in a PEI occasion corresponding to determined PF/PO.

If a low power wakeup signal is supported by the UE and the network, the network entity (i.e., base station or gNB) transmits a low power wakeup signal before the determined PEI occasion or before the determined PF/PO.

In one embodiment of this disclosure, a UE operation for paging is as follows:

A UE receives N and other paging configurations (such as pagingSearchSpace, Ns, default DRX cycle etc.) from a network element (e.g., base station or gNB). The signaling can be via system information (such as SIB or SIB1), or an RRC message or SI message or any other message.

The UE determines the PF/PO for paging.

If the SSB periodicity is >160 ms and pagingSearchSpace is zero (alternately, if the SSB periodicity is >160 ms and pagingSearchSpace is zero and if the SS/PBCH block and CORESET multiplexing pattern is 2 or 3), the UE determines N and PF_Offset from the configuration of nAndPagingFrameOffset. Alternately, the UE determines N from the configuration of nAndPagingFrameOffset. PF offset=offset from SFN 0 to start of SSB burst.

Otherwise, the UE determines N and PF_Offset from the configuration of nAndPagingFrameOffset.

If the paging search space is zero (or if the paging search space is zero and if the SS/PBCH block and CORESET multiplexing pattern is 2 or 3), if the SSB periodicity>160 ms, to determine the PDCCH monitoring occasions for paging, the UE assumes that the SSB periodicity is 160 ms.

The PF is the radio frame (SFN) which satisfies:

$$( SFN + PF\_Offset ) mod T = ( T div N ) * ( UE\_ID mod N ) .$$

The Index (i_s), indicating the index of the PO is determined by:

$$i\_s = floor ( UE\_ID / N ) mod Ns .$$

UE_ID can be 5G-S-TMSI mod Y where Y can be 1024, 2048, 4096, 8192, 16384, etc.

The UE monitors paging (i.e., PDCCH addressed to P-RNTI) in the determined PF/PO.

In case paging early indication (PEI) is supported, the UE monitors for a PEI in a PEI occasion corresponding to the determined PF/PO. The UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

If a low power wakeup signal is supported by the UE and the network, the UE monitors for an LP WUS before the determined PEI occasion or before the determined PF/PO. If the LP WUS is received (or an LP WUS for the UE/UE specific paging subgroup is received), the UE monitors for a PEI (using MR) and/or subsequently the UE monitors the determined PO (using MR) and receives a paging message if a PEI indicates paging for the UE/UE specific paging subgroup (or a bit in the PEI corresponding to the UE's paging subgroup is set to 1 or in case there are no paging subgroups supported in the cell, there is one bit common for all UEs in the PEI and the bit is set to 1).

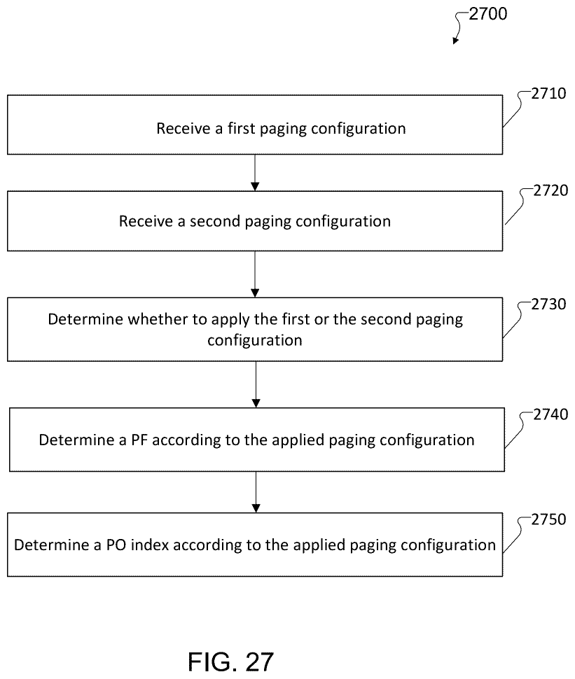

FIG. 27 illustrates a method 2700 for bundling paging occasions according to embodiments of the present disclosure. An embodiment of the method illustrated in FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments bundling paging occasions could be used without departing from the scope of this disclosure.

The method 2700 begins at step 2710. At step 2710, a UE, such as UE 116 of FIG. 1, receives a first paging configuration. At step 2170, the UE receives a second paging configuration. At step 2730, the UE determines whether to apply the first or the second paging configuration. At step 2740, the UE determines a PF according to the applied paging configuration. Finally, at step 2750, the UE determines a PO index according the to the applied paging configuration.

Although FIG. 27 illustrates one example of a method 2700 for bundling paging occasions, various changes may be made to FIG. 27. For example, while shown as a series of steps, various steps in FIG. 27 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive a first paging configuration; and
receive a second paging configuration; and
a processor operably coupled to the transceiver, the processor configured to:
determine whether to apply the first or the second paging configuration; and
according to the applied paging configuration:
determine a paging frame (PF); and
determine a paging occasion (PO) index.

2. The UE of claim 1, wherein:
the first paging configuration includes:
a first number of paging occasions for a PF (Ns);
a first number of paging frames (N); and
a paging frame offset (PF_Offset); and
the second paging configuration includes:
a second number of paging occasions for a PF (Ns′);
a duration over which PFs are bundled (D);
a second number of paging frames (N1) in the duration, D;
an offset (offset); and
an interval at which bundled PFs occur periodically (X).

3. The UE of claim 2, wherein:
when the first paging configuration is applied:
a system frame number (SFN) for the PF is determined by (SFN+PF_offset) mod T=(T div N)*(UE_ID mod N); and
the PO index is determined by i_s=floor (UE ID/N) mod Ns; and
when the second paging configuration is applied:
the SFN for the PF is determined by (SFN+offset) mod T=(D div N1)*(UE_ID mod N1); and
the PO index is determined by i_s=floor (UE_ID/N1) mod Ns′,
wherein:
T is a discontinuous reception (DRX) cycle of the UE; and
i_s is an index indicating the index of the PO.

4. The UE of claim 1, wherein:
the first paging configuration includes:
nrofPDCCH-MonitoringOccasionPerSSB-InPO;
firstPDCCH-MonitoringOccasionOfPO; and
pagingSearchSpace;
the second paging configuration includes:
nrofPDCCH-MonitoringOccasionPerSSB-InPO′;
firstPDCCH-MonitoringOccasionOfPO′; and
pagingSearchSpace′; and
the processor is further configured to:
when the first paging configuration is applied, determine physical downlink control channel (PDCCH) monitoring occasions for paging according to nrofPDCCH-MonitoringOccasionPerSSB-InPO, firstPDCCH-MonitoringOccasionOfPO, and pagingSearchSpace; and
when the second paging configuration is applied, determine PDCCH monitoring occasions for paging according to nrofPDCCH-MonitoringOccasionPerSSB-InPO′, firstPDCCH-MonitoringOccasionOfPO′, and pagingSearchSpace′.

5. The UE of claim 1, wherein:
the transceiver is further configured to receive an indication to use a PF bundling configuration; and
the processor is further configured to, based on the indication, apply the second paging configuration.

6. The UE of claim 1, wherein the processor is further configured to:
determine whether a network energy savings mode is activated; and
upon a determination that the network energy savings mode is activated, apply the second paging configuration.

7. The UE of claim 1, wherein the processor is further configured to:
determine whether the UE supports PF bundling; and
upon a determination that the UE supports PF bundling, apply the second paging configuration.

8. A base station (BS) comprising:
a transceiver configured to:
transmit a first paging configuration; and
transmit a second paging configuration; and
a processor operably coupled to the transceiver, the processor configured to:
determine whether to apply the first or the second paging configuration; and
according to the applied paging configuration:
determine a paging frame (PF); and
determine a paging occasion (PO) index.

9. The BS of claim 8, wherein:
the first paging configuration includes:
a first number of paging occasions for a PF (Ns);
a first number of paging frames (N); and
a paging frame offset (PF_Offset); and
the second paging configuration includes:
a second number of paging occasions for a PF (Ns′);
a duration over which PFs are bundled (D);
a second number of paging frames (N1) in the duration, D;
an offset (offset); and
an interval at which bundled PFs occur periodically (X).

10. The BS of claim 9, wherein:
when the first paging configuration is applied:
a system frame number (SFN) for the PF is determined by (SFN+PF_offset) mod T=(T div N)*(UE_ID mod N); and
the PO index is determined by i_s=floor (UE ID/N) mod Ns; and
when the second paging configuration is applied:
the SFN for the PF is determined by (SFN+offset) mod T=(D div N1)*(UE_ID mod N1); and
the PO index is determined by i_s=floor (UE_ID/N1) mod Ns′,
wherein:
T is a discontinuous reception (DRX) cycle of a UE; and
i_s is an index indicating the index of the PO.

11. The BS of claim 8, wherein:
the first paging configuration includes:
nrofPDCCH-MonitoringOccasionPerSSB-InPO;
firstPDCCH-MonitoringOccasionOfPO; and
pagingSearchSpace;
the second paging configuration includes:
nrofPDCCH-MonitoringOccasionPerSSB-InPO′;
firstPDCCH-MonitoringOccasionOfPO′; and
pagingSearchSpace′; and
the processor is further configured to:
when the first paging configuration is applied, determine physical downlink control channel (PDCCH) monitoring occasions for paging according to nrofPDCCH-MonitoringOccasionPerSSB-InPO, firstPDCCH-MonitoringOccasionOfPO, and pagingSearchSpace; and
when the second paging configuration is applied, determine PDCCH monitoring occasions for paging according to nrofPDCCH-MonitoringOccasionPerSSB-InPO′, firstPDCCH-MonitoringOccasionOfPO′, and pagingSearchSpace′.

12. The BS of claim 8, wherein:
the transceiver is further configured to transmit an indication to use a PF bundling configuration; and
the processor is further configured to, based on the indication, apply the second paging configuration.

13. The BS of claim 8, wherein the processor is further configured to:
determine whether a network energy savings mode is activated; and
upon a determination that the network energy savings mode is activated, apply the second paging configuration.

14. A method of operating a user equipment (UE), the method comprising:
receiving a first paging configuration;
receiving a second paging configuration;
determining whether to apply the first or the second paging configuration; and
according to the applied paging configuration:
determining a paging frame (PF); and
determining a paging occasion (PO) index.

15. The method of claim 14, wherein:
the first paging configuration includes:
a first number of paging occasions for a PF (Ns);
a first number of paging frames (N); and
a paging frame offset (PF_Offset); and
the second paging configuration includes:
a second number of paging occasions for a PF (Ns′);
a duration over which PFs are bundled (D);
a second number of paging frames (N1) in the duration, D;
an offset (offset); and
an interval at which bundled PFs occur periodically (X).

16. The method of claim 15, further comprising:
when the first paging configuration is applied:
determining a system frame number (SFN) for the PF by (SFN+PF_offset) mod T=(T div N)*(UE_ID mod N); and
determining the PO index by i_s=floor (UE ID/N) mod Ns; and
when the second paging configuration is applied:
determining the SFN for the PF by (SFN+offset) mod T=(D div N1)*(UE_ID mod N1); and
determining the PO index by i_s=floor (UE_ID/N1) mod Ns′,
wherein:
T is a discontinuous reception (DRX) cycle of the UE; and
i_s is an index indicating the index of the PO.

17. The method of claim 14, wherein:
the first paging configuration includes:
nrofPDCCH-MonitoringOccasionPerSSB-InPO;
firstPDCCH-MonitoringOccasionOfPO; and
pagingSearchSpace;
the second paging configuration includes:
nrofPDCCH-MonitoringOccasionPerSSB-InPO′;
firstPDCCH-MonitoringOccasionOfPO′; and
pagingSearchSpace′; and
the method further includes:
when the first paging configuration is applied, determining physical downlink control channel (PDCCH) monitoring occasions for paging according to nrofPDCCH-MonitoringOccasionPerSSB-InPO, firstPDCCH-MonitoringOccasionOfPO, and pagingSearchSpace; and
when the second paging configuration is applied, determining PDCCH monitoring occasions for paging according to nrofPDCCH-MonitoringOccasionPerSSB-InPO′, firstPDCCH-MonitoringOccasionOfPO′, and pagingSearchSpace′.

18. The method of claim 14, further comprising:
receiving an indication to use a PF bundling configuration; and
based on the indication, applying the second paging configuration.

19. The method of claim 14, further comprising:
determining whether a network energy savings mode is activated; and
upon a determination that the network energy savings mode is activated, apply the second paging configuration.

20. The method of claim 14, further comprising:
determining whether the UE supports PF bundling; and
upon a determination that the UE supports PF bundling, applying the second paging configuration.
